(19) United States
(12) Patent Application Publication
(10) Pub. No.: US 2017/0225782 A1
(43) Pub. Date: Aug. 10, 2017

(54) STOWABLE UNMANNED AERIAL VEHICLES AND ASSOCIATED SYSTEMS AND METHODS

(71) Applicant: Nixie Labs, Inc., Mountain View, CA (US)

(72) Inventors: Christoph Kohstall, Palo Alto, CA (US); Jelena Jovanovic, Palo Alto, CA (US); Dylan Owens, Palo Alto, CA (US); Nathan Leefer, Palo Alto, CA (US); Ben Sampson, Palo Alto, CA (US)

(21) Appl. No.: 15/268,225

(22) Filed: Sep. 16, 2016

Related U.S. Application Data
(60) Provisional application No. 62/220,849, filed on Sep. 18, 2015.
(60) Provisional application No. 62/298,942, filed on Feb. 23, 2016.

(51) Int. Cl. B64C 39/02; B64C 1/06; B64F 5/10; B64D 47/08

(52) U.S. Cl. CPC B64C 39/024; B64D 47/08; B64C 1/063; B64F 5/10; B64C 2201/027; B64C 2201/042; B64C 2201/108; B64C 2201/127; B64C 2201/203; B64C 2201/205; B64C 2201/206; B64C 2201/208

(57) ABSTRACT

Stowable and deployable unmanned aerial vehicles (UAVs), and associated systems and methods are disclosed. A UAV in accordance with a particular embodiment includes a main body, frames carried by the main body, and motors carried by the frames. At least two frames are positioned to move relative to each other between a stowed configuration in which the frames are generally aligned proximate to each other and a deployed configuration different from the stowed configuration. The main body can include a first body portion pivotably connected to a second body portion. In a stowed configuration, the body portions can generally overlap each other. A UAV in accordance with particular embodiments includes a modular electronics unit carried by the UAV and including a camera, a battery, and a vehicle controller. Modular electronics units can be configured to be removably connected to and disconnected from the UAV and other vehicles.

### CROSS-REFERENCE TO RELATED APPLICATIONS

The present application claims priority to U.S. Provisional Patent Application No. 62/220,849, filed Sep. 18, 2015, and to U.S. Provisional Patent Application No. 62/298,942, filed Feb. 23, 2016, each of which is incorporated herein in its entirety by reference.

### TECHNICAL FIELD

The present technology is directed generally to stowable and deployable unmanned aerial vehicles, and associated systems and methods.

### BACKGROUND

Unmanned aerial vehicles (UAVs) have been used in a wide variety of capacities to provide surveillance and perform other tasks. Personal UAVs have become very popular over the last several years as a tool to provide individuals with an aerial perspective. One drawback with personal UAVs, even small personal UAVs, is that although they may be portable, they typically cannot be stowed easily for secure or convenient transport, and they may be bulky or awkward to handle when not in use.

### BRIEF DESCRIPTION OF THE DRAWINGS

FIG. 1 illustrates attachments between a UAV and a user's body, clothing, or gear according to several embodiments of the present technology.

FIG. 2 illustrates a UAV in a stowed configuration in accordance with an embodiment of the present technology.

FIG. 3 illustrates the UAV shown in FIG. 2 in a deployed configuration.

FIG. 4 illustrates a partially exploded view of the UAV shown in FIG. 2.

FIG. 5 illustrates the UAV shown hi FIG. 2 having a release button in accordance with an embodiment of the present technology.

FIG. 6 illustrates a portion of a frame of the UAV shown in FIG. 2 in accordance with an embodiment of the present technology.

FIG. 7 illustrates a bottom perspective view of a portion of the UAV shown in FIG. 2.

FIG. 8 illustrates a sectional view of the UAV shown in FIG. 2.

FIG. 9 illustrates a UAV in accordance with another embodiment of the present technology.

FIG. 10A illustrates a UAV in accordance with another embodiment of the present technology in a stowed configuration.

FIG. 10B illustrates a cross-sectional view of the UAV shown in FIG. 10A in accordance with an embodiment of the present technology.

FIG. 11 illustrates the UAV shown in FIG. 10A in a deployed configuration.

FIG. 12 illustrates a top perspective view of the UAV shown in FIG. 10A in a stowed configuration.

FIGS. 13A, 13B, and 13C illustrate an embodiment of a mechanism for deploying the rotors and motors of the UAV shown in FIG. 10A.

FIG. 14A illustrates a generally circular snap feature for assembling a top portion to a bottom portion of the UAV shown in FIG. 10A.

FIG. 14B illustrates a cross-sectional view of a representative rotatable connection between a top portion and a bottom portion of the UAV shown in FIG. 10A in accordance with an embodiment of the present technology.

FIG. 15A illustrates a mechanism for controlling or limiting rotational motion between a top portion and a bottom portion of the UAV shown in FIG. 10A, in accordance with an embodiment of the present technology.

FIG. 15B illustrates a mechanism for controlling or limiting rotational motion between a top portion and a bottom portion of the UAV shown in FIG. 10A, in accordance with another embodiment of the present technology.

FIG. 15C schematically illustrates operation of the mechanism shown in FIG. 15B.

FIG. 16A illustrates the UAV shown in FIG. 10A in a stowed configuration in a user's grasp.

FIG. 16B illustrates the UAV shown in FIG. 10A in a deployed configuration in a user's grasp.

FIG. 17 illustrates a modular electronics unit in accordance with several embodiments of the present technology.

FIG. 18 illustrates several implementations of the modular electronics unit shown in FIG. 17 in various vehicles according to several embodiments of the present technology.

FIG. 19 illustrates a perspective view of a UAV in a deployed configuration in accordance with several embodiments of the present technology.

FIG. 20 illustrates the UAV shown in FIG. 19 in a folded or stowed configuration according to embodiments of the present technology.

FIG. 21 illustrates a bottom perspective view of the UAV shown in FIG. 19 having a hinge in accordance with an embodiment of the present technology.

FIG. 21A illustrates a close-up view of the hinge shown in FIG. 21.

FIG. 21B illustrates a bottom perspective view of the UAV shown in FIG. 19 and a partial cutaway view of the hinge shown in FIG. 21.

FIG. 21C illustrates a close-up detailed partial cutaway view of the hinge shown in FIG. 21.

FIG. 21D illustrates an exploded view of several elements of the hinge shown in FIG. 21 in accordance with an embodiment of the present technology.

FIG. 22 illustrates a bottom perspective view of the UAV shown in FIG. 19 in a partially folded configuration and having a hinge with an elastic loop in accordance with another embodiment of the present technology.

FIG. 22A illustrates a close-up detailed view of the elastic loop associated with the hinge shown in FIG. 22.

FIGS. 22B, 22C, and 22D illustrate side cutaway views of the UAV shown in FIGS. 22 and 22A in various deployment configurations and with the elastic loop of the hinge mechanism.

FIGS. 23A-23E illustrate perspective views of the UAV shown in FIG. 19 in various stages between a stowed configuration (FIG. 23A) and a deployed configuration (FIG. 23E).

FIGS. 24A-24E illustrate side views of the UAV shown in FIG. 19 in various stages between a stowed configuration (FIG. 24A) and a deployed configuration (FIG. 24E), corresponding with FIGS. 23A-23E.

FIG. 25 illustrates a perspective view of a UAV in accordance with another embodiment of the present technology.

FIG. 26 illustrates a perspective view of a UAV in accordance with another embodiment of the present technology.

FIG. 27 illustrates a perspective view of the UAV shown in FIG. 26 in a configuration in which a modular electronics unit has been disassembled from the UAV in accordance with an embodiment of the present technology.

FIG. 28A illustrates a perspective view of a UAV in a deployed configuration in accordance with another embodiment of the present technology.

FIG. 28B illustrates the UAV shown in FIG. 28A in transition between a deployed configuration and a stowed configuration.

FIG. 28C illustrates a perspective view of the UAV shown in FIG. 28A in a stowed configuration.

FIG. 29 illustrates a perspective view of a UAV in an unfolded or deployed configuration in accordance with another embodiment of the presently disclosed technology.

FIG. 30 illustrates a top view of the UAV shown in FIG. 29.

FIG. 31 illustrates a perspective view of the UAV shown in FIG. 29 in a configuration in which it is partially folded, between the unfolded or deployed configuration (FIGS. 29 and 30) and the folded or stowed configuration (generally shown in FIG. 32).

FIG. 32 illustrates the UAV shown in FIG. 29 in a folded or stowed configuration in accordance with a representative embodiment of the presently disclosed technology.

FIG. 33 illustrates a top view of the UAV shown in FIG. 29 in the folded or stowed configuration.

FIG. 34A illustrates a partially schematic, partially disassembled top view of a spring-biased hinge mechanism positioned in the hinge in accordance with an embodiment of the presently disclosed technology.

FIG. 34B illustrates a close-up, detailed and partially schematic view of a portion of the hinge mechanism shown in FIG. 34A.

FIG. 35 illustrates an exploded view of several components of the hinge mechanism shown in FIG. 34B.

FIG. 35A illustrates a cover portion that can be installed over the hinge mechanism shown in FIG. 34A in accordance with an embodiment of the presently disclosed technology.

FIG. 35B illustrates an exploded view of parts of the UAV shown in FIG. 34A.

FIG. 36A illustrates a partially schematic top view of the main body of a UAV in accordance with another embodiment of the presently disclosed technology.

FIG. 36B illustrates a partially schematic cross-sectional view of the main body of the UAV shown in FIG. 36A.

### DETAILED DESCRIPTION

The presently disclosed technology is directed generally to stowable and deployable unmanned aerial vehicles (UAVs), and associated systems and methods. In particular embodiments, the vehicles can have various form factors with various mechanisms to allow the UAVs to be placed in a stowed state or configuration and a deployed state or configuration. The present technology also includes various mounting or carrying systems and arrangements for UAVs. In addition, the present technology includes a modular electronics unit with a camera and/or a controller configured to be used in a number of various embodiments of vehicle systems. For example, modular electronics units configured in accordance with embodiments of the present technology are removably connectable to and disconnectable from UAVs or other vehicles, in one piece.

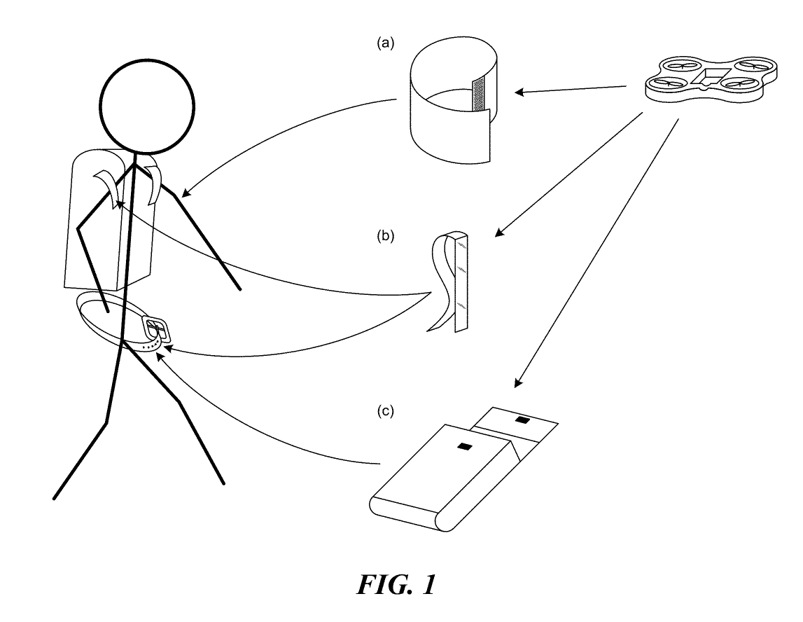

Specific details of several embodiments of the disclosed technology are described below with reference to example form factors of unmanned aerial vehicles to provide a thorough understanding of these embodiments. In other embodiments, the UAVs can have other form factors utilizing various deployment mechanisms and deployment configurations. Several details describing structures or processes that are well-known and often associated with UAVs are not set forth in the following description for purposes of clarity. Moreover, although the following disclosure sets forth several embodiments of different aspects of the disclosed technology, several other embodiments of the technology can have different configurations or different components than those described in this section. As such, the technology can have other embodiments with additional elements and/or without several of the elements described below with reference to FIGS. 1-36B.

Certain aspects of the present technology are directed to stowable and deployable UAVs. As used herein, the terms “stowable” and “deployable” refer generally to characteristics of a UAV that can be manipulated from a deployed configuration suitable for flight, maintenance, or other operations, into a generally more compact stowed form, such as a collapsed or folded form or configuration for transportation, protection, convenience, and/or storage. Instead of remaining in a deployed state before and/or after flight operations, a representative UAV in accordance with an embodiment of the presently disclosed technology can be stowed in order to provide a convenient form for storage or transportation. Particular embodiments of stowable and deployable UAV configurations and related mechanisms are described below with reference to FIGS. 1-36B.

The reduced overall dimensions of a stowable and deployable UAV in a stowed configuration allow for easier storage, more convenient portability, and/or can facilitate protection of sensitive or fragile parts. Representative stowable and deployable UAVs disclosed herein can be attached directly to a user's body, clothing, or gear. As illustrated in FIG. 1, for example, embodiments of UAVs in accordance with the presently disclosed technology can attach to a user or a user's clothing or gear using (a) a Velcro® hook-and-loop fastener, (b) a magnet or a clip, (c) a dock or case, and/or other suitable arrangements. In other embodiments, the UAV or its dock or case (connects to clothing or gear using a carabiner through an opening in the UAV (such as a propeller guard or shroud described below and illustrated in several figures herein) or an opening in the dock or case. In yet other embodiments, the UAV or its dock or case can connect to a sling which can be worn around the neck or wrist of the user.

In particular, embodiments of UAVs disclosed herein can be stored directly in a user's pocket (e.g., a cargo pocket or front pocket of a pair of pants, or in a shirt pocket), on a user's belt, on a strap of a user's luggage (e.g., a backpack chest or shoulder strap), on an upper or lower arm (e.g., attached to an armband), or in a purse or backpack, or other suitable container. If a strap is used, the strap can be configured to hold the UAV flush with the user or the user's gear or luggage. UAVs in accordance with representative embodiments of the presently disclosed technology can be stored in a dock or case that can, in turn, attach to a user's body, clothing, or gear. A dock or case in accordance with the presently disclosed technology can offer physical protection and functionality, such as recharging, or it can act as a beacon for location or navigational assistance, as further described below.

Embodiments of docks or cases for UAVs of the presently disclosed technology can include a pouch with a top opening (similar to a rock climber's chalk bag), a hard case with an open face, or a backing plate that a UAV can be slid or capped onto. Docks and/or cases in accordance with the presently disclosed technology can provide protection (such as from damage by crushing or dropping) and/or a power source (such as a battery that charges the UAV between flights). Representative docks and/or cases can also provide navigational features, such as navigational features to keep the UAV in a position or orientation relative to the user or to help the UAV return to the user or dock for recapture and/or charging, for example. For example, a GPS module or system in the dock can provide the UAV with the user's location, or the dock can generate ultrasonic signals that can be detected by the UAV to allow distance and relative orientation of a user to be determined. An infrared (“IR”) light source in the case or dock can additionally or alternatively allow the UAV to detect a user's location, and/or a radio frequency (“RF”) signal can be emitted by the dock or the UAV to allow range and heading to be determined. In some embodiments, a dock and/or case of the presently disclosed technology can process images captured by the UAV, and in yet other embodiments, the dock or case can provide communications links (such as WiFi™, Bluetooth®, or cellular data) to assist with transfer of images, video, or related data. A dock and/or case in accordance with the present technology can be used with any of the embodiments or form factors of UAVs disclosed herein.

In several specific embodiments, the present technology provides mechanisms that bias the UAVs toward closed or stowed configurations for storage, and toward open or deployed configurations for flight, and away from configurations in between the stowed and deployed configurations. Each of these biases can be achieved with an over-center mechanism, which creates a bi-stable tendency to stay deployed or stowed, but generally restricts or prevents changes between these configurations without a specific action by the user. Examples of over-center mechanisms are described in further detail below. In some embodiments, a compression spring that is maximally compressed at a middle position, or an extension spring that is maximally extended at a middle position can be used. Alternatively, a UAV in accordance with the presently disclosed technology can have a loaded spring pressure when stowed that is released or unsprung when deployed. A user can reload the spring by manipulating the UAV into a stowed configuration. A catch or locking mechanism can hold the UAV in the stowed configuration and it can be unlocked by a user before deploying for flight. In other embodiments, a catch or locking mechanism can hold the UAV in the deployed configuration, while a spring-loaded mechanism can bias the UAV towards the stowed configuration. Suitable combinations of springs and latches can be used in various embodiments of stowable and deployable UAVs.

The present technology can also provide a user with the ability to stow and deploy a UAV with one hand. This can be accomplished by securing the UAV against a generally stable object for manipulation with one hand, or via designs that otherwise facilitate one-handed operation. The individual embodiments disclosed herein can be operated with one hand, or using one hand and a supporting surface, such as the body of a user. Wiring configurations for embodiments disclosed below can include wires and cables suitable for repeated flexure. Further particular embodiments of stowable and deployable UAV configurations are described below.

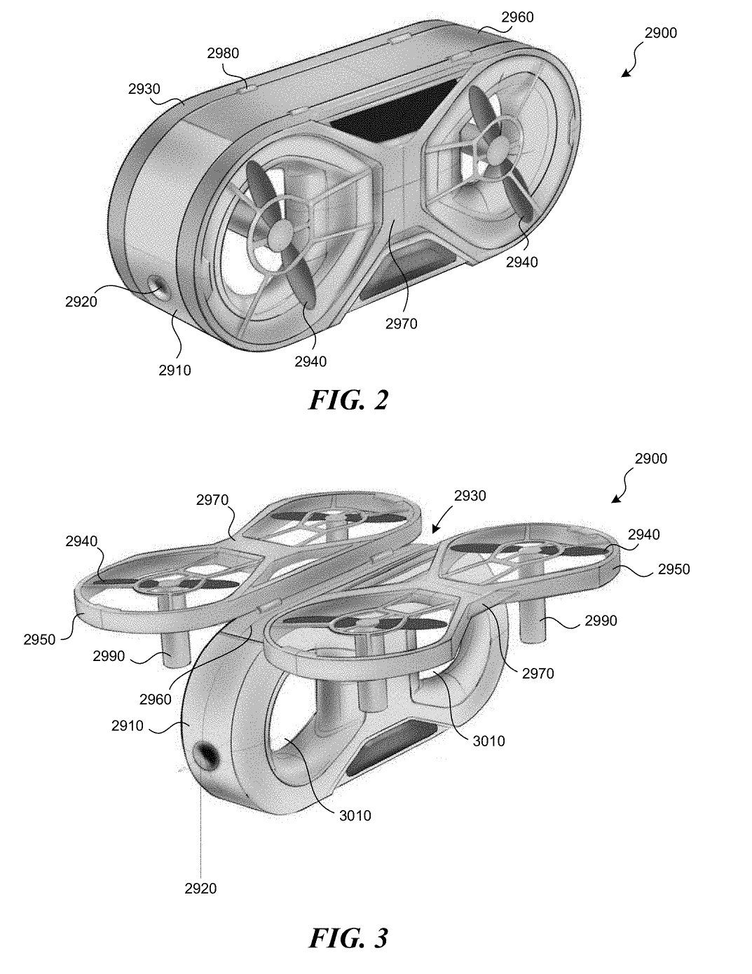

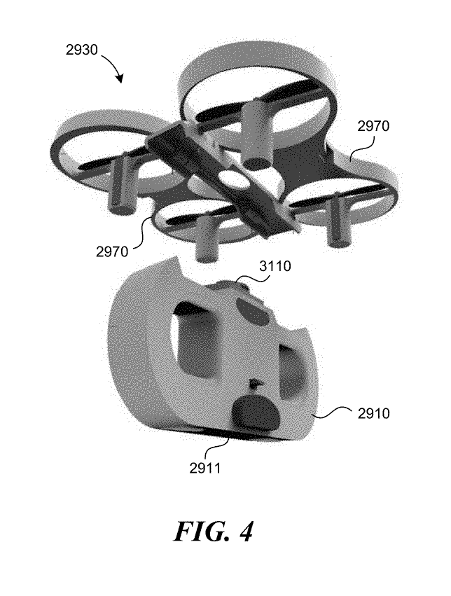

FIGS. 2 and 3 are perspective views of a UAV 2900 configured in accordance with an embodiment of the present technology and shown in a stowed configuration (FIG. 2) and a deployed configuration (FIG. 3). The UAV 2900 can include a modular electronics unit 2910 (which may also be called an electronics module, modular unit, or electronics pod) that in turn includes a camera 2920, electronics (e.g., for propulsion, guidance, and/or control of the UAV and/or communication with the UAV), and/or a battery. The modular electronics unit 2910 attaches to a frame 2930 that carries rotors 2940 for propulsion. Referring to FIG. 3, the frame 2930 can further include an attachment portion 2960 that supports a pair of shroud portions 2970 via a hinged connection 2980 that allows the frame to be folded or hinged around the modular electronics unit 2910 for storage (as generally illustrated in FIG. 2).

The shroud portions 2970 can support the rotors 2940, motors 2990, and/or shrouds 2950. The frame 2930 can be opened to a generally flat configuration when the UAV 2900 is in a deployed configuration, as generally illustrated in FIG. 3. The motors 2990 can be staggered to fit next to each other within openings 3010 in the modular electronics unit 2910 when the UAV 2900 is in the stowed configuration. The camera 2920 and/or camera lens can be positioned on an end portion of the modular electronics unit 2910, or it can be positioned in other suitable locations. In some embodiments, the UAV 2900 can have a length of approximately 5.50 inches, and in other embodiments, the UAV 2900 can have other suitable dimensions.

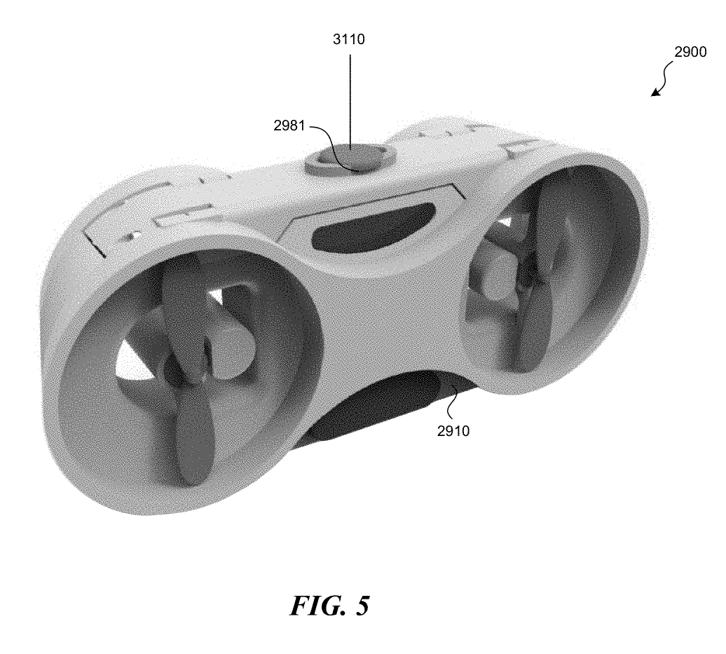

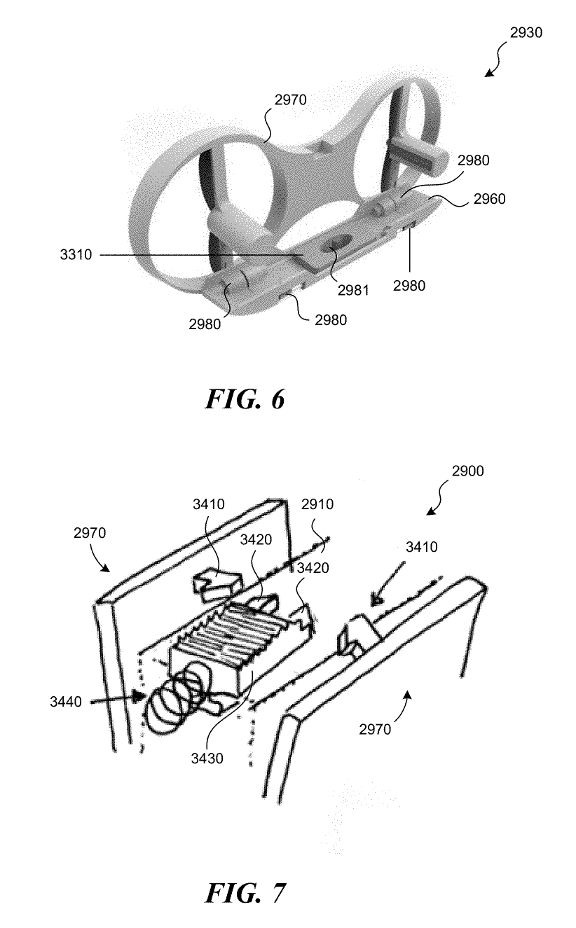

In a particular aspect of the embodiment shown in FIGS. 2 and 3, the modular electronics unit 2910 is releasably connected to the rest of the UAV 2900 (e.g., the frame 2930). FIG. 4 illustrates the frame 2930 removed from the modular electronics unit 2910. In accordance with several embodiments of the present technology, the modular electronics unit 2910 can be replaceable, upgradeable, or detachable so as to fit with another frame (for example, if a frame is damaged). Suitable mechanisms can be used to attach and detach the frame from the modular electronics unit 2910. For example, a release button 3110 can facilitate release of the frame from the modular electronics unit 2910, as generally illustrated in FIG. 5, for example. A USB port 2911 (see FIG. 4) can be included in the modular electronics unit 2910 for charging and/or communication with the modular electronics unit.

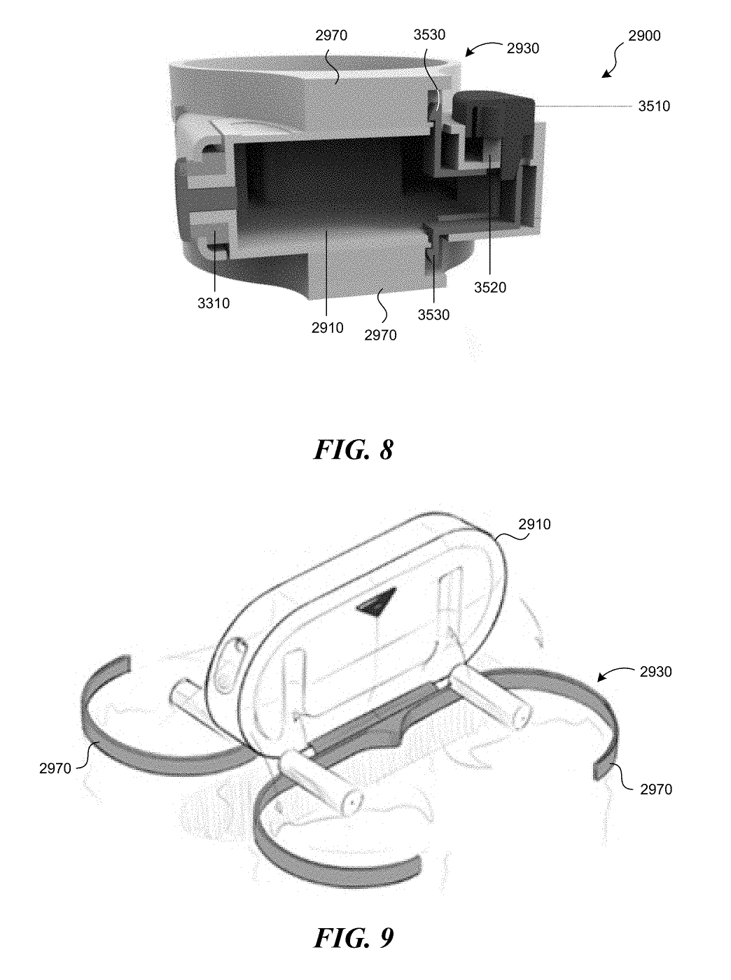

FIG. 6 generally illustrates a portion of the frame 2930. The frame 2930 can include a damping gasket 3310 for vibration isolation, with the gasket 3310 positioned between the modular electronics unit 2910 (FIG. 4) and the attachment portion 2960 of the frame 2930, for example, around the opening 2981 for the release button 3110 (FIG. 5). In FIG. 6, four hinged connections 2980 are illustrated between the attachment portion 2960 and the shroud portions 2970 (only one shroud portion 2970 is shown) for facilitating stowage and deployment of the frame 2930, although other suitable numbers of hinged connections 2980 can be used in other embodiments. Each hinged connection 2980 can include a coil spring, retained by one or more pins, to provide torsion to bias the frame 2930 toward the unfolded or deployed configuration (as in FIG. 3, for example). Accordingly, the frame 2930 will remain open or deployed unless locked into a stowed configuration using a suitable mechanism.

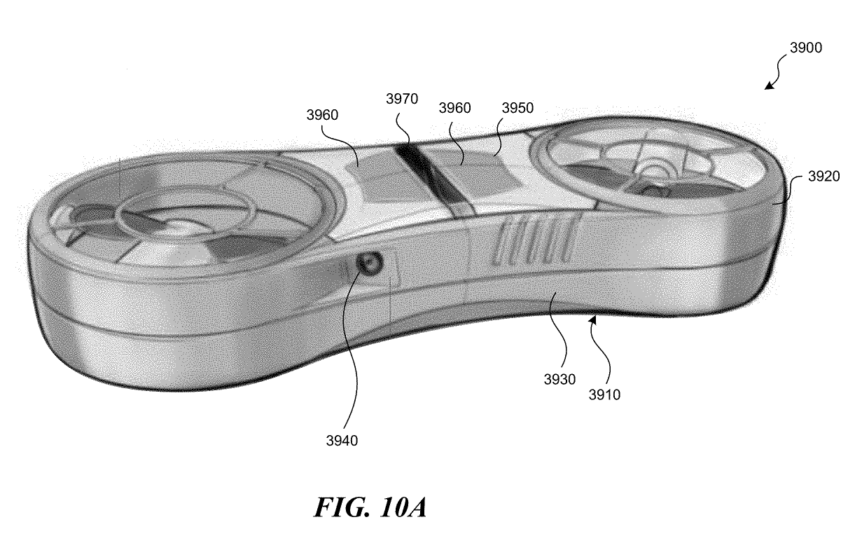

FIG. 7 is a bottom perspective view of a portion of the UAV 2900 shown in FIG. 2, illustrating a suitable mechanism for changing between stowed and deployed configurations. The shroud portions 2970, which are biased away from the modular electronics unit 2910 toward an unfolded or deployed configuration (FIG. 3), can include hooks 3410 that are retained by corresponding latches 3420 connected to a sliding button 3430 mounted to the modular electronics unit 2910, for example. A spring 3440 can be used to bias the sliding button 3430 toward a position that retains the hooks 3410 within the latches 3420. To deploy the UAV 2900, the user can move the sliding button 3430 to release the hooks 3410 from the latches 3420, thereby allowing the frame 2930 to spring open to the deployed configuration. Stops (not visible) on the frame can prevent the frame from opening beyond a flat configuration. To return the UAV 2900 to a stowed configuration, the user can push the shroud portions 2970 of the frame 2930 toward the modular electronics unit 2910 until the hooks 3410 are retained by the latches 3420.

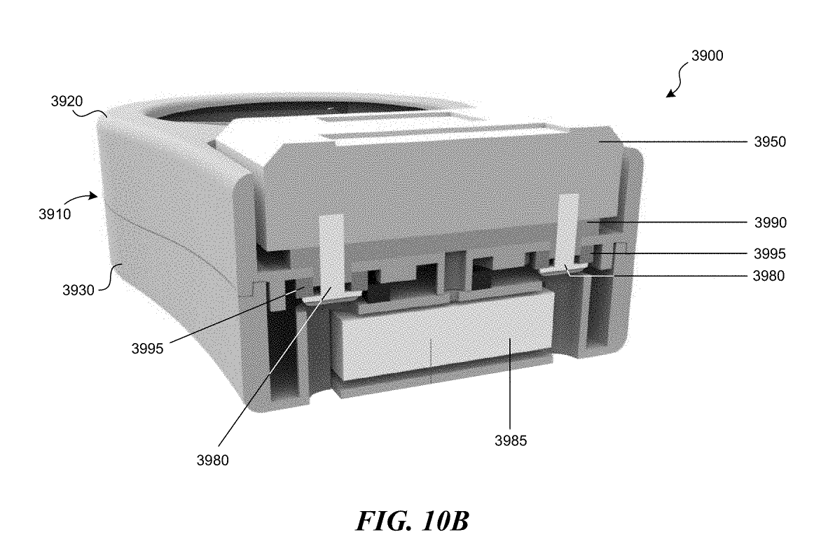

FIG. 8 illustrates a side cross-sectional view of an embodiment of the UAV 2900 having a mechanism for retaining and deploying the frame 2930. The mechanism can include a button 3510 that is depressed against the force of a compression spring (not visible, but positioned beneath the button 3510 in area 3520) to release latches or catches 3530 from the shroud portions 2970 so that the shroud portions 2970 can spring open for flight.

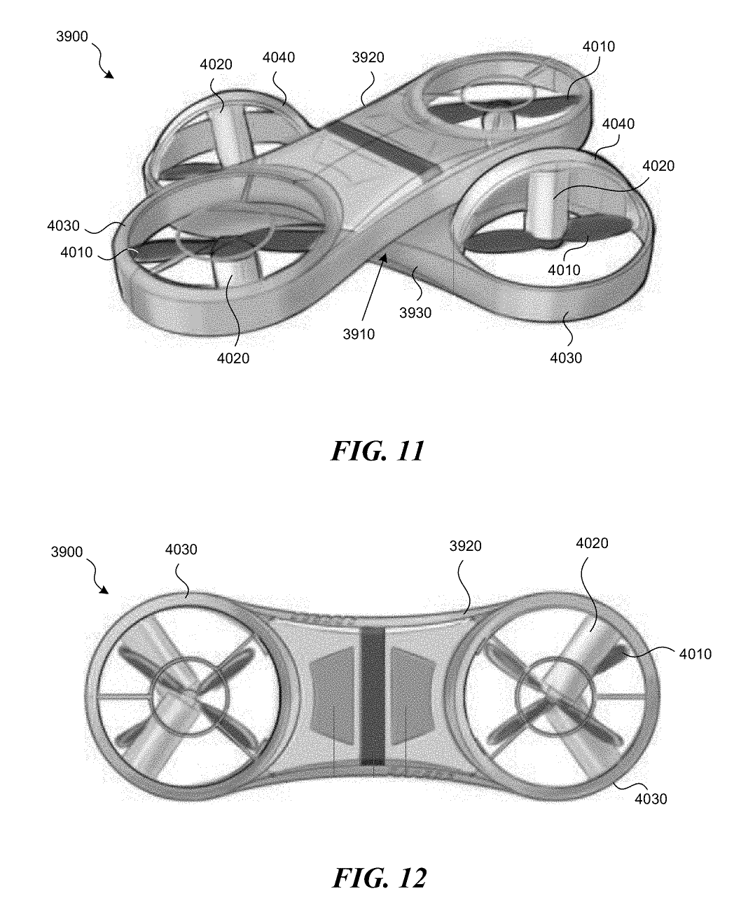

FIGS. 2-8 generally illustrate embodiments for which the modular electronics unit 2910 hangs from the frame during flight. In other embodiments, for example, as illustrated in FIG. 9, the modular electronics unit 2910 can be positioned above the frame 2930 during flight, such that the shroud portions 2970 pivot at the bottom edge of the modular electronics unit, while generally similar mechanisms and features can be used for stowage and deployment. In particular embodiments, the foregoing arrangements can facilitate a modular UAV configuration, in which the modular electronics unit can operate in any of a variety of vehicles. Further details of representative embodiments are described below.

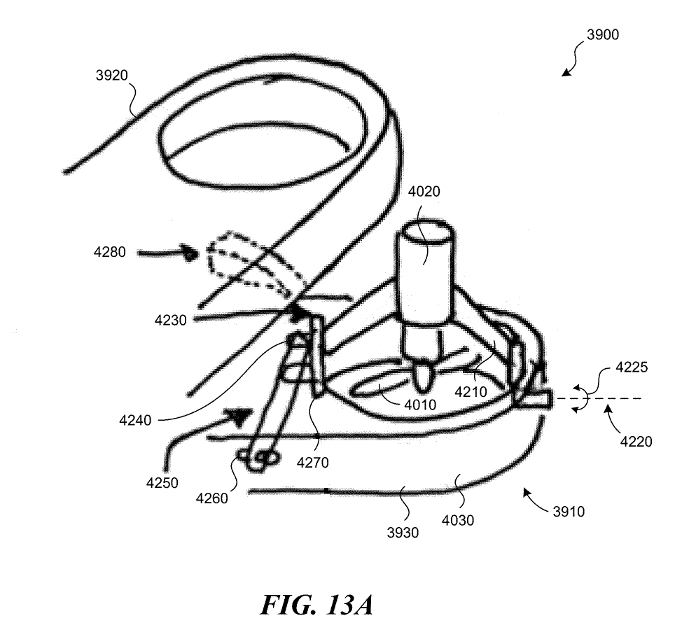

FIG. 10A illustrates a perspective view of a UAV 3900 in a stowed configuration in accordance with another embodiment of the presently disclosed technology. The UAV 3900 includes a body 3910 having an upper or top portion 3920 and a lower or bottom portion 3930, separated along a generally horizontal plane and configured to rotate with respect to each other. One of the portions 3920, 3930 can include a port or opening 3940 that allows an internal camera access outside the body 3910. A camera and/or a modular electronics unit 3950 that includes a camera can be inserted (e.g., removably) into the UAV 3900. The modular electronics unit 3950 can include buttons 3960 to cycle through and select modes for operation of the UAV 3900, and it can also include a display screen 3970 for providing feedback to the user. The UAV 3900 can be stored compactly, in a relatively shallow space, with the top portion 3920 aligned with the bottom portion 3930 as generally illustrated in FIG. 10A. In some embodiments, the UAV 3900 in a stowed configuration can have a length of approximately 6.75 inches, while in other embodiments, the UAV 3900 can have other suitable dimensions.

FIG. 10B shows a cross-sectional view of the UAV 3900 in the stowed configuration in accordance with an embodiment of the present technology. The modular electronics unit 3950 can be retained or removed using attachment screws 3980 that can be accessed from a battery compartment (storing a battery 3985) in the bottom portion 3930. In some embodiments, the modular electronics unit 3950 can be retained using other attachment implements, such as one or more quick-release connections. The camera and/or other electronics in the modular electronics unit 3950 can be vibration-isolated from the rest of the body 3910 using foam or rubber mounts that permit motion of the module relative to the body. For example, to limit or isolate vibration, a damping gasket 3990 can be positioned between the module 3950 and the UAV body 3910, and additionally or alternatively, damping disks 3995 can be positioned between the screws 3980 and the UAV body 3910. The battery 3985 can be isolated from vibration in a similar fashion, or it can be included as a part of the modular electronics unit 3950.

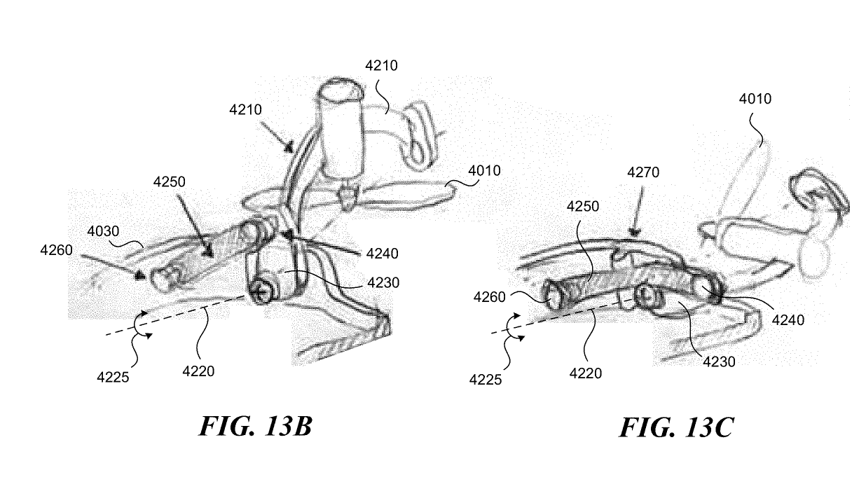

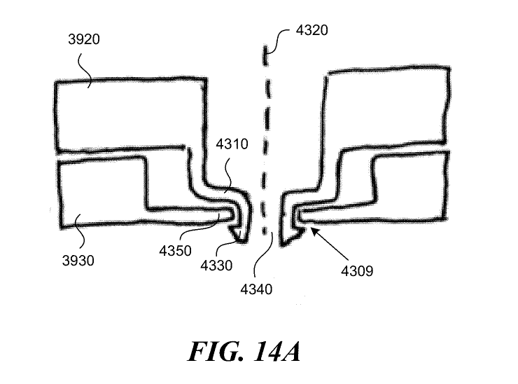

A user can deploy the UAV 3900 for flight by rotating the top portion 3920 with respect to the bottom portion 3930, as generally illustrated in FIG. 11. The top portion 3920 can include a rotor 4010 and motor 4020 at each end, each generally surrounded by a shroud 4030. Similarly, the bottom portion 3930 can include a rotor 4010 and a motor 4020 at each end, with the rotor 4010 generally surrounded by a shroud 4030. The top portion 3920 and the bottom portion 3930 can be positioned at an angle with respect to each other such that the rotors are spaced apart for flight. Each motor and rotor can be attached to a pivoting or gimbaling bow or arc 4040 that is generally horizontal or parallel with the body and contained within a corresponding shroud 4030 when the UAV 3900 is in the stowed configuration (as in FIG. 10A, for example). When a user changes the UAV 3900 from a stowed configuration to a deployed configuration, the gimbaling arcs 4040 are free to pivot with respect to the shrouds 4030 so that the gimbaling arcs 4040 generally extend out of a plane of the body 3910 and the rotors 4010 are directed generally downward to provide lift. When a user stows the UAV 3900, the body portions 3920, 3930 push the gimbaling arcs 4040 such that they rotate back into and generally parallel to the shrouds 4030. As generally illustrated in FIG. 12, which is a top view of a UAV 3900, the motors 4020 and rotors 4010 are tucked within the shrouds 4030 for protection in the stowed configuration. The gimbaling arcs 4040 can be spring loaded to be biased toward the deployed, out-of-plane configuration generally illustrated in FIG. 11.

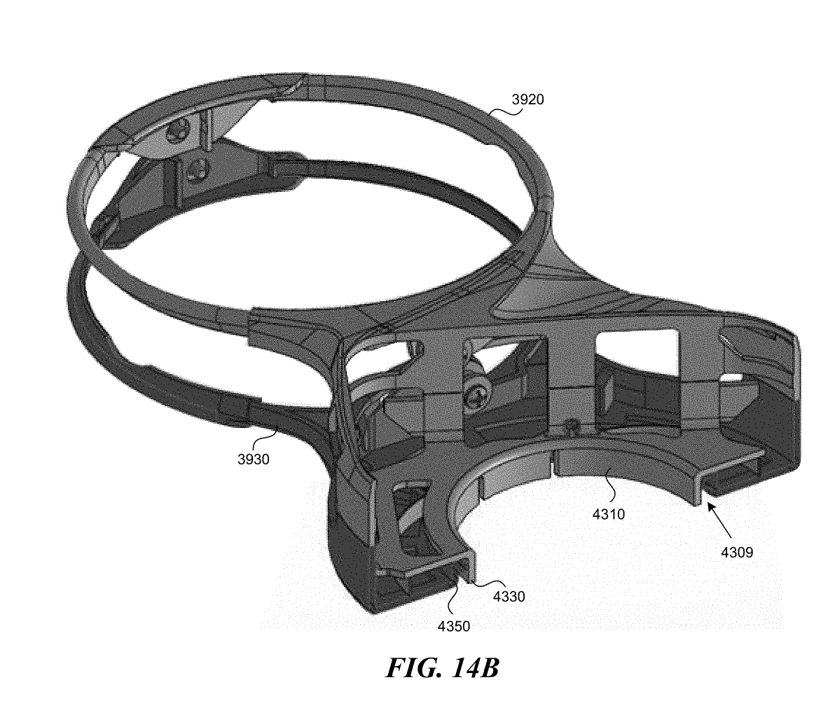

FIGS. 13A, 13B, and 13C illustrate another embodiment of a gimbaling mechanism for deploying the rotors 4010 and motors 4020 of the UAV 3900, FIGS. 13A and 13B generally illustrate partial perspective views of the gimbal mechanism in a deployed state. FIG. 13C generally illustrates a partial perspective view of the gimbal mechanism in a folded or stowed state. The gimbaling arc 4210 pivots within a shroud 4030 about an axis 4220 (as illustrated by an arrow 4225) generally defined by gimbal pivot points, where the gimbaling arc 4210 can connect to the UAV body 3910 (for example, to the bottom portion 3930 as illustrated). The gimbaling arc 4210 can have a cam or lobe 4230 (which may be teardrop-shaped, for example) attached to or integral with the gimbaling arc 4210. The lobe 4230 can further include a gimbal peg 4240 positioned at a distance from the pivot point about the axis 4220. The lobe 4230 and peg 4240 can retain a tension spring or elastic band 4250, which can be further connected to a frame peg 4260 on the UAV body 3910 (for example, on the bottom portion 3930 as illustrated).

In operation, the elastic band 4250 provides a force that tends to bias the gimbaling arc 4210 to an open or deployed position (e.g., as shown in FIGS. 13A and 13B) due to the tension between the frame peg 4260 and the gimbal peg 4240 from the elastic band 4250. Because the gimbaling arc 4210 can rely on the moment or torque applied to the lobe 4230 about the axis 4220 by the elastic band 4250, it is generally undesirable to allow the elastic band 4250 to be in a straight configuration when the gimbal peg 4240, the frame peg 4260, and the pivot point at axis 4220 are aligned. Therefore, in some embodiments, the mechanism can be arranged or positioned to ensure that the elastic band 4250 is prevented from reaching a straight-line condition when the gimbal peg 4240, the frame peg 4260, and the pivot point at the axis 4220 are aligned. For example, the configuration can include a protrusion (such as a screw) from the pivot point at the axis 4220 to bend the elastic band 4250 when the gimbaling arc 4210 is in the stowed configuration (as generally illustrated in FIG. 13C). Such a protrusion ensures that the elastic band 4250 provides a moment about the axis 4220. To prevent the gimbaling arc 4210 from opening beyond a desired deployed position, a gimbal stop 4270 can be attached to or be integral with a portion of the UAV body 3910 (for example, the bottom portion 3930) to stop the gimbaling arc 4210 when it has reached the deployed position.

Further, the gimbaling arc 4210 or the lobe 4230 (being attached to the bottom portion 3930, for example) can make contact with the UAV body 3910 (at the top portion, 3920, for example) which resists the tendency of the gimbaling arc 4210 to open to a deployed position until the UAV body 3910 (e.g., top portion 3920) is out of the path of the opening gimbaling arc 4210. In some embodiments, the gimbaling arc 4210 or the lobe 4230 can directly contact the UAV body 3910 at an edge (e,g., an edge of the top portion 3920). In other embodiments, a guide ramp 4280 in the UAV body 3910 (for example, in the top portion 3920) can accommodate the lobe 4230 sliding therein, allowing the gimbaling arc 4210 to rotate between stowed and deployed configurations in a controlled manner. For example, the shape of the guide ramp 4280 can determine the speed with which the gimbaling arc 4210 rotates to the deployed position (FIGS. 13A and 13B) or to the stowed position (FIG. 13C). And by controlling the shape of the guide ramp 4280, the UAV 3900 can be configured to close with minimal interference between the gimbals, rotors, and body portions.

Although the gimbal mechanism has been illustrated with particular elements on the top portion 3920 or the bottom portion 3930 of the UAV 3900, each element can be appropriately positioned in other configurations in order to use the gimbal mechanism for each of the four rotors and motors. In some embodiments, a torsion spring positioned about the axis 4220 can be used in lieu of the elastic band 4250 to provide the bias to the gimbal arc 4210 toward the deployed configuration.

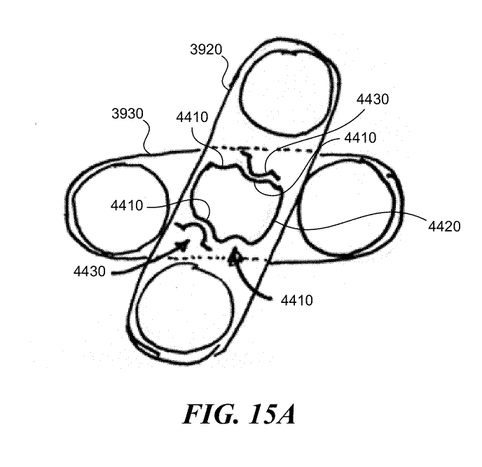

FIG. 14A illustrates a generally circular snap feature 4309 for assembling the top portion 3920 to the bottom portion 3930 of the UAV 3900. The top portion 3920 can include a generally cylindrical extension 4310 positioned about an axis of rotation 4320 with a generally circumferential latch edge 4330 that passes through a hole 4340 in the bottom portion 3930 and is retained by a corresponding ledge 4350 of the bottom portion 3930. The top and bottom portions 3920, 3930 of the UAV 3900 can rotate relative to each other about the interface between the extension 4310 and the hole 4340 and ledge 4350, so as to move between the stowed and deployed positions. In other embodiments, the cylindrical extension 4310 can be part of the bottom portion 3930, while the hole 4340 can be in the top portion 3920: In yet other embodiments, other suitable rotatable connections can be used to assemble the top portion 3920 to the bottom portion 3930 of the UAV 3900. FIG. 14B generally illustrates a cross-sectional view of a representative rotatable connection.

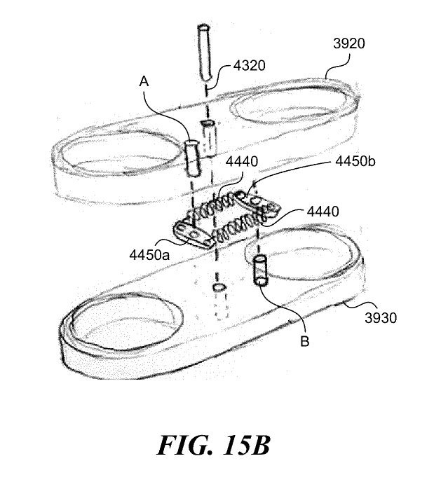

FIG. 15A illustrates a mechanism for controlling or limiting rotational motion between the top portion 3920 and the bottom portion 3930, the mechanism having detent features 4410 in a rounded track 4420 attached to or integral with the upper portion 3920 in cooperation with opposing arc-shaped springs 4430 attached to the lower portion 3930. The detent features 4410 releasably lock the UAV 3900 into the stowed and deployed configurations. By including a pair of opposing springs 4430, the bearing loads at the pivot between the bodies (e.g., the pivot illustrated generally in FIG. 14A) is reduced or minimized. A user deploying or stowing the UAV 3900 can “click” the lower portion 3930 and upper portion 3920 into their respective places using the detents 4410 and springs 4430. In some embodiments, the rounded track 4420 can be attached to or integral with the lower portion 3930, while the springs 4430 can be attached to the upper portion 3920. In other embodiments, other suitable mechanisms for limiting or controlling rotational motion between the lower portion 3930 and the upper portion 3920 can be used.

FIG. 15B illustrates another embodiment of a mechanism to limit or control rotational motion between the top portion 3920 and the bottom portion 3930. In FIG. 15B, a pair of extension springs 4440 are connected at their ends by hinged links 4450a, 4450b that are each configured to pivot with respect to the UAV 3900. A first hinged link 4450a can be connected to the top portion 3920 to pivot around pivot point A, while a second hinged link 4450b can be connected to the bottom portion 3930 to pivot around pivot point B. The springs 4440 straddle the center rotational axis 4320 of the UAV 3900. In operation, as generally illustrated in the sequence shown in FIG. 15C, when the UAV 3900 is partway between a stowed and deployed configuration, the extension springs 4440 are most elongated, and when the UAV 3900 is at either the stowed or deployed configuration, the extension springs 4440 are least elongated. In this embodiment, the extension springs 4440 resist a position in which the UAV 3900 is partway between a deployed and stowed configuration, which tends to keep the UAV 3900 in either the deployed or stowed configuration after a user has manipulated the UAV into the selected position.

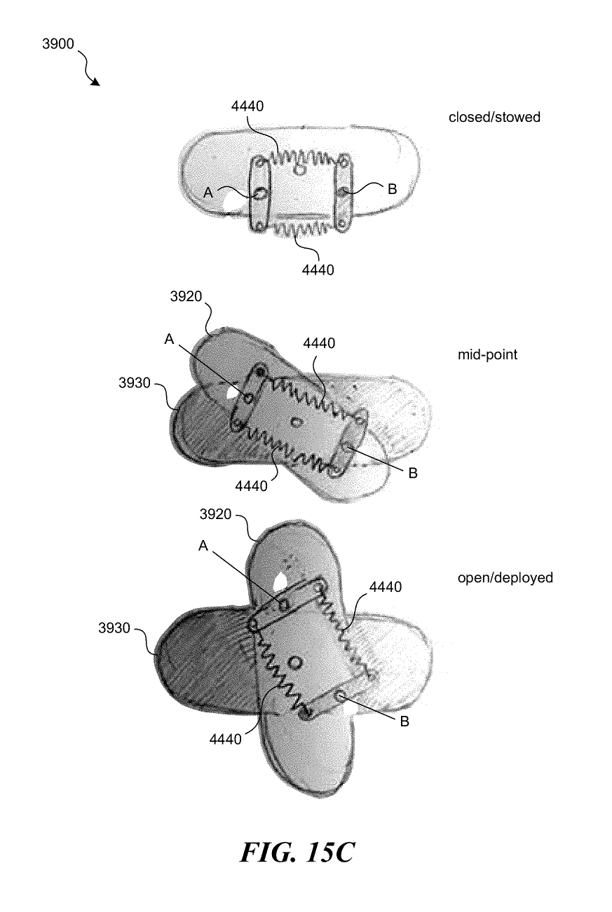

FIG. 16A generally illustrates a stowed UAV 3900 in a user's grasp. The UAV 3900 can be held in one hand and rotated or scissored open to a deployed configuration as generally illustrated in FIG. 16B. A user can catch the UAV 3900 near a front or side face by grasping a center region of the body. The UAV 3900 can have buttons 3901, 3902 for various functions.

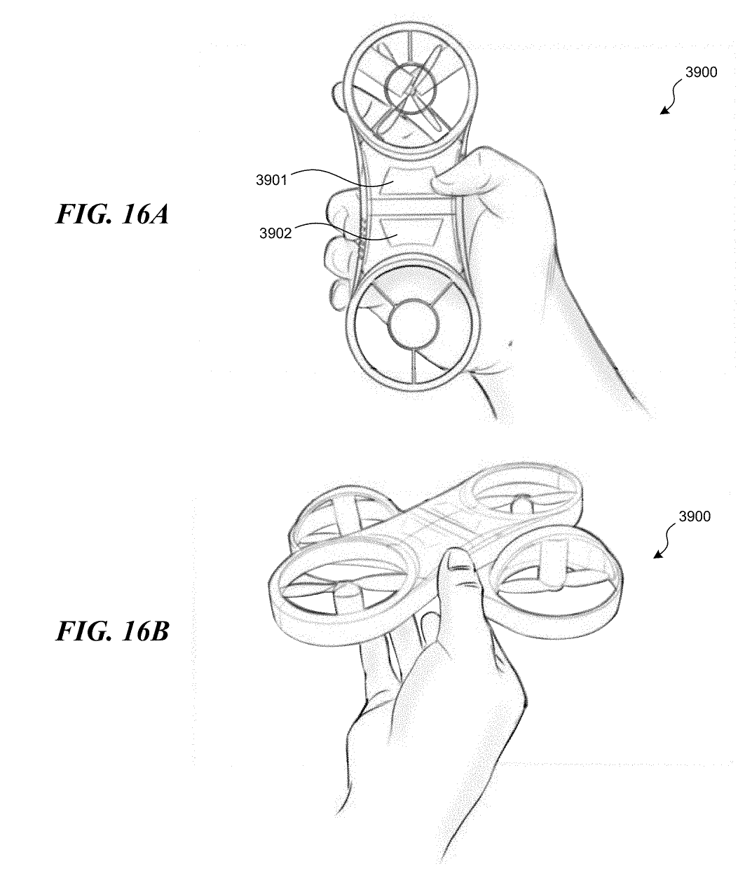

In embodiments of the presently disclosed technology, electronics, a camera, a battery, a vehicle controller, and/or other components may be contained in a single modular electronics unit (i.e., carried by or contained within a single housing) that can be installed into one or more of the above UAVs. The modular electronics unit can be multifunctional or it can have a single general function. For example, a removable multifunctional modular electronics unit 820 (such as generally illustrated in FIG. 17) can include a screen, electronics, a camera, and/or control buttons contained within a housing 821. Such a modular electronics unit can be configured or shaped to be received in multiple types of vehicles, such as the embodiment generally illustrated in FIGS. 10A and 10B, or in any number of other vehicles configured in accordance with the presently disclosed technology. The modular electronics unit 820 can be standardized to be received in standardized openings or receivers in various vehicles. In other embodiments, such a module or unit can allow the camera to be operated independently of the UAV in situations where flying is unnecessary.

FIG. 17 illustrates a modular electronics unit 820 in accordance with several embodiments of the technology. The modular electronics unit 820 can be multifunctional, and it can include a camera 5310 and/or electronics, such as a battery and/or control electronics for controlling (e.g., operating) a vehicle. The modular electronics unit 820 can connect to a vehicle or other device in a socket 5320 on the vehicle. To enable installation and removal of the modular electronics unit 820, the modular electronics unit 820 can have flat or resilient spring-loaded electrical contacts 5330 that contact corresponding resilient or spring-loaded electrical contacts 5335 when the modular electronics unit 820 is in the socket 5320. The modular electronics unit 820 can include one or more resilient or spring-loaded protrusions 5340 that engage with corresponding notches 5345 in the socket 5320 to hold the modular electronics unit 820 in the socket 5320. In other embodiments, other suitable electrical contacts and/or mechanisms to retain the modular electronics unit 820 can be used. The modular electronics unit 820 and the socket 5320 can be suitably shaped or sized as desired to accommodate a range of vehicles or design constraints. In some embodiments, the modular electronics unit 820 can be approximately rectangular in shape, for example. In further embodiments, the socket 5320 can contain a spare battery.

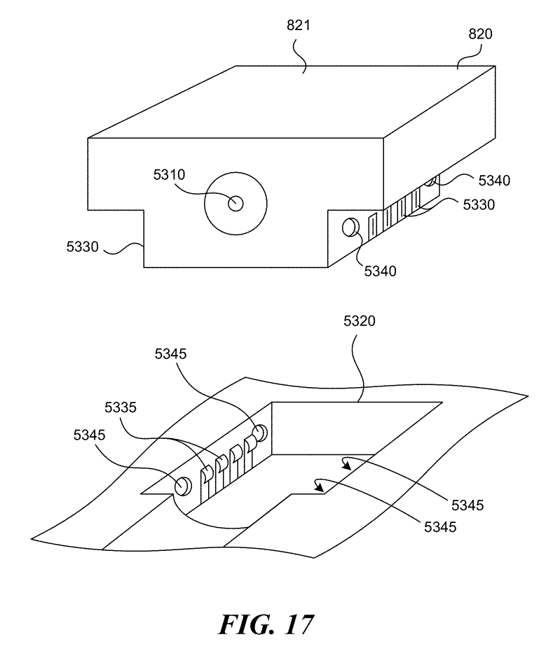

FIG. 18 illustrates several implementations of a modular electronics unit 820 configured to be installed in various vehicles according to several embodiments of the present technology. The modular electronics unit 820 can control, power, and/or take photographs from various vehicles. For example, the modular electronics unit 820 can be installed in a UAV 5410 to control, power, and/or take photographs from the UAV 5410. The UAV 5410 can be configured in accordance with the technology disclosed herein, or it can have other configurations.

In some embodiments, the modular electronics unit 820 can be installed on a tripod 5420 having telescoping legs 5425. The tripod 5420 can include a first motor 5430 positioned to rotate a first base 5435 about a yaw axis 5437 relative to the legs 5425. The tripod 5420 can further include a second motor 5438 positioned to rotate a second base 5439 relative to the first base 5435 about a pitch axis 5440. The modular electronics unit 820 can capture photographs and/or control the motors 5430, 5438 to automatically position the camera 5310. In some embodiments, the modular electronics unit 820 can allow manual control and/or remote control of the camera and motors. In other embodiments, the tripod 5420 can include a third axis and a third motor for an additional degree of freedom. Optionally, the modular electronics unit 820 can power the motors 5430, 5438.

In other embodiments, the modular electronics unit 820 can be installed in a ground vehicle, such as the ground vehicle 5450 illustrated in FIG. 18. The modular electronics unit 820 can be placed in the socket 5320 on a platform 5451 driven by one or more motorized wheels 5455. A swiveling or caster wheel 5457 can support a part of the platform 5451 opposite the wheels 5455. In yet other embodiments, the modular electronics unit 820 can be installed in an underwater platform 5464. The modular electronics unit 820 can be configured to control motors 5465 and rotors 5466 distributed about the platform 5464. And in other embodiments, the modular electronics unit 820 can be installed in a motorized, balancing two-wheel platform 5470. The two-wheel platform 5470 can be an approximately human-sized robot, for example, or it may be other sizes. The modular electronics unit 820 can autonomously control vehicles to autonomously photograph or record using the camera 5310. Accordingly, a modular electronics unit in accordance with embodiments of the present technology can be attached to a variety of autonomous vehicles, including other aircraft, ground vehicles, water surface vehicles, and submersibles. The core control system in such a modular electronics unit can be configured to adapt to each vehicle as the modular electronics unit is moved between vehicle types. The modular electronics unit can have a “plug-and-play” configuration, with little to no user input or adjustment necessary to switch from controlling one vehicle to controlling another vehicle.

Despite best efforts, UAVs may crash, and even durable devices may experience broken parts. Accordingly, a modular electronics unit from a damaged vehicle can be provided to a new vehicle. Additionally, if a UAV airframe, body, or other part is broken, a user can relatively inexpensively replace independent components. For example, in some embodiments, the motors can include spring-loaded electrical contacts, rather than a permanent attachment, so as to be readily connected to and disconnected from electronics.

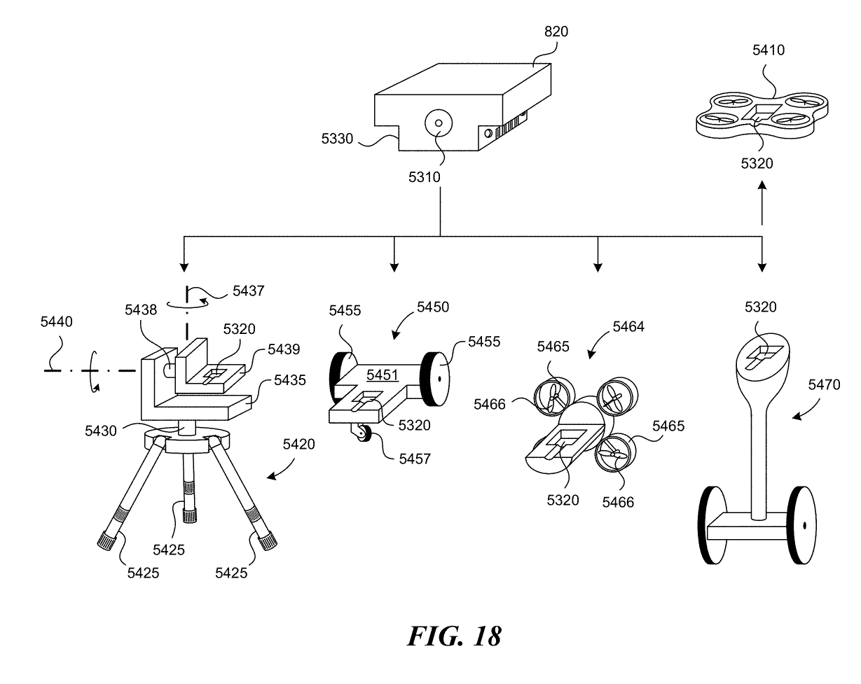

FIGS. 19-25 illustrate another UAV 5500 configured in accordance with several embodiments of the presently disclosed technology. FIG. 19 illustrates a perspective view of the UAV 5500 in a deployed configuration in which two frame portions or frames 5510 are positioned in an unfolded orientation with respect to each other. Each frame 5510 may support one or more rotors 5520 (for example, two) and corresponding motors 5530 for driving the rotors 5520. In the unfolded orientation, the rotors 5520 are positioned to impart a force (e.g., lift) to the UAV 5500 for flight operations. The frames 5510 can include contoured rotor shrouds 5540 and motor supports 5550 to hold the motors 5530 in the UAV 5500. In a particular embodiment, one of the frames 5510 can be attached to or integral with a main body portion 5560, while another frame 5510 can be connected to the first frame 5510 by a hinged connection, as illustrated and described in additional detail below. The frames 5510 can be formed from plastic, metal, a composite material, or any other suitable material capable of providing lightweight structural support. When unfolded, the frames 5510 need not unfold to a fully fiat configuration. Rather, they may unfold to any suitable angle. In some embodiments, the UAV 5500 can resemble the shape of a flying insect (e.g., a butterfly).

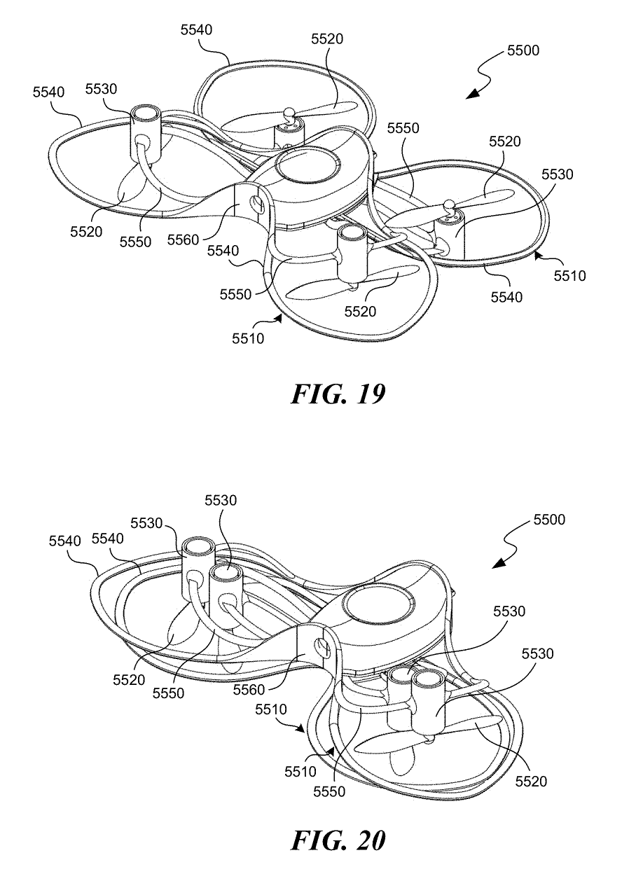

FIG. 20 illustrates the UAV 5500 in a folded or stowed configuration. In such a configuration, the frames 5510 can be generally aligned with each other, e.g., over each other. The motor supports 5550 can be designed so that the motors 5530 nest together adjacent to each other to allow the frames 5510 to fold closely together to reduce (e.g., minimize) the space required for a stowed UAV 5500.

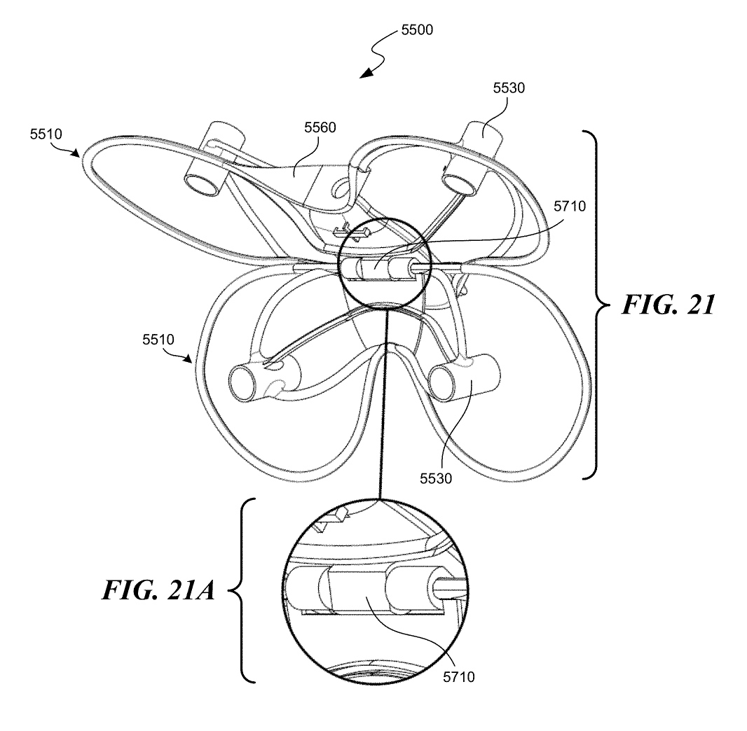

FIGS. 21, 21A, 21B, 21C, and 21D generally illustrate an embodiment of a hinge mechanism 5710 for a UAV 5500 configured in accordance with an embodiment of the present technology. For simplicity of illustration, the rotors 5520 are not illustrated. FIG. 21 illustrates a position of the hinge 5710 in the UAV 5500 in which the hinge 5710 allows the frames 5510 to rotate or articulate relative to each other between the stowed and deployed configurations. FIG. 21A illustrates a close-up, detailed view of the hinge 5710.

FIG. 21B illustrates a partial cutaway view of the hinge 5710 in the UAV 5500. FIG. 21C illustrates a close-up detailed partial cutaway view of the hinge 5710. Internal elements of the hinge 5710 are generally illustrated in FIG. 21D. A spring 5720 can be compressed into a housing 5730 by a first detent element 5740 having a first angled face 5745 and a rectangular base. A corresponding second detent element 5750 having a second angled face 5755 can be positioned adjacent to the first detent element 5740 such that the angled faces 5745, 5755 of each detent element 5740, 5750 are in contact with each other and are forced together under pressure from the spring 5720. The detent elements 5740, 5750 can slide toward and away from each other in the assembly. The angled faces 5745, 5755 are positioned to rotate relative to each other as the frames 5510 of the UAV 5500 are opened and closed between stowed and deployed configurations. As the angled faces 5745, 5755 rotate with respect to each other, the detent elements 5740, 5750 move closer together or farther apart. The angled faces 5745, 5755 meet at a point of the greatest force from the spring 5720. The spring force against the angled faces 5745, 5755 causes the hinge 5710 to be biased toward either an unfolded or deployed configuration (i.e., the configuration generally illustrated in FIG. 19) or a folded or stowed configuration (i.e., the configuration generally illustrated in FIG. 20). The hinge 5710 is biased away from a configuration in between such stowed and deployed configurations. Accordingly, the hinge 5710 is a bi-stable mechanism. Other suitable bi-stable hinge mechanism can be used in other embodiments of the technology.

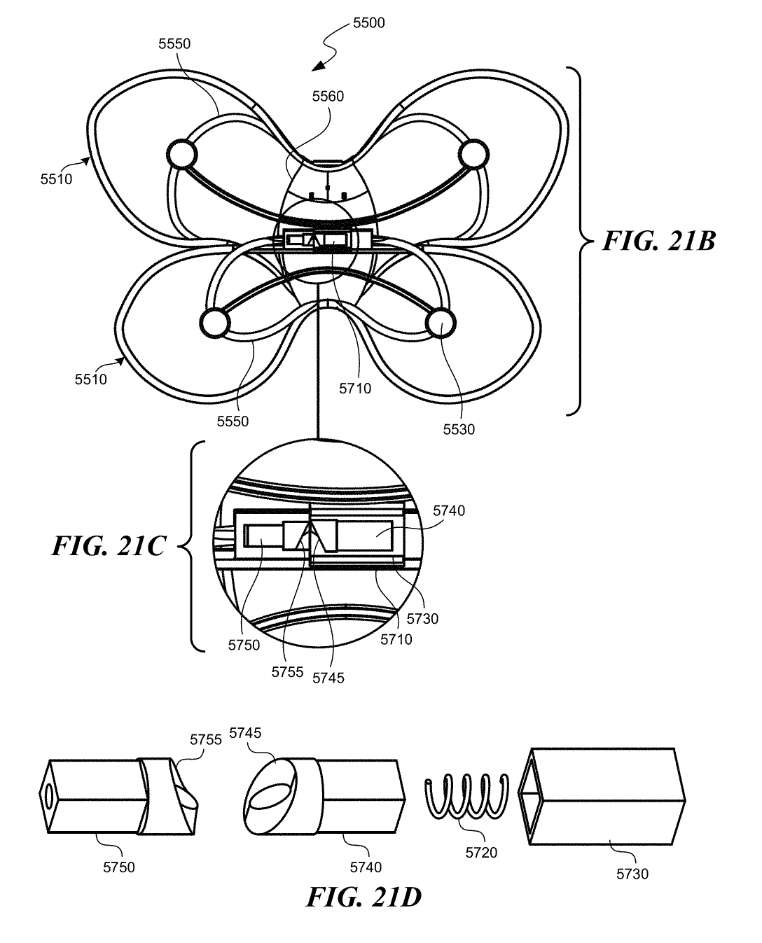

For example, FIGS. 22, 22A, 22B, 22C, and 22D illustrate a bi-stable hinge mechanism 5800 in accordance with another embodiment of the present technology. FIG. 22 illustrates a UAV 5500 in a partially folded configuration in which the frames 5510 are positioned at an angle with respect to each other. An elastic loop 5810 can be placed near an axis of rotation between the frames, as further described below. FIG. 22A illustrates a close-up detailed view of the elastic loop 5810 associated with the hinge mechanism 5800.

FIGS. 22B, 22C, and 220 illustrate cutaway views of the hinge mechanism 5800, along with the elastic loop 5810, with the UAV 5500 in various deployment configurations. The elastic loop 5810 is positioned around an axis of rotation between the frames 5510. It passes through one or more holes (for example, two) in the main body 5560 and connects to a portion of one or both of the frames 5510. Tension on the elastic loop when the UAV 5500 is in a deployed configuration is equal to tension when the UAV 5500 is in a stowed configuration. Accordingly, the elastic loop 5810 tends to bias the UAV 5500 toward either a stowed or a deployed configuration, and away from a configuration in between the stowed and deployed configurations. Although bi-stable hinges have been described as having an elastic loop or as having detents with angled faces, other bi-stable hinge mechanisms can be used in other embodiments of the technology.

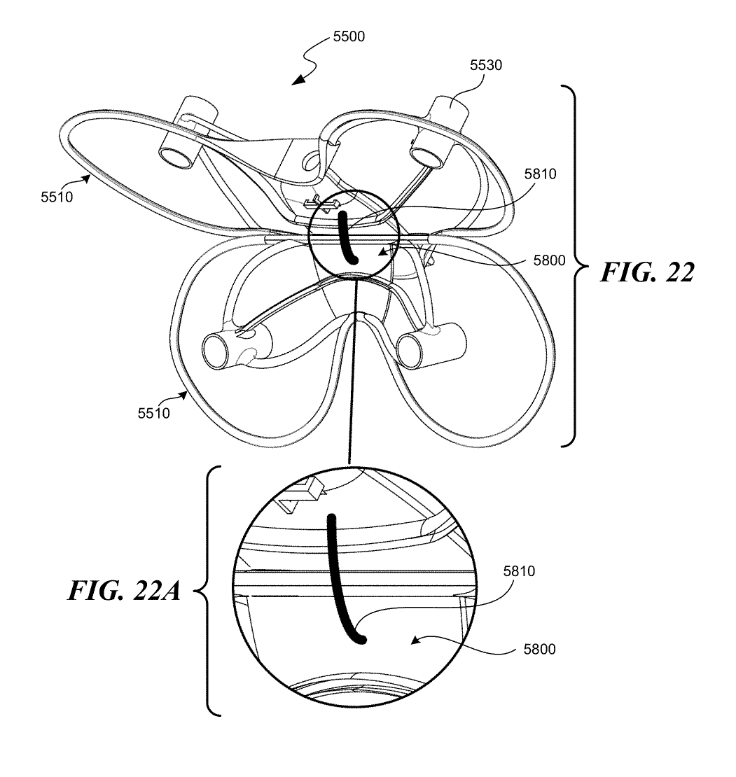

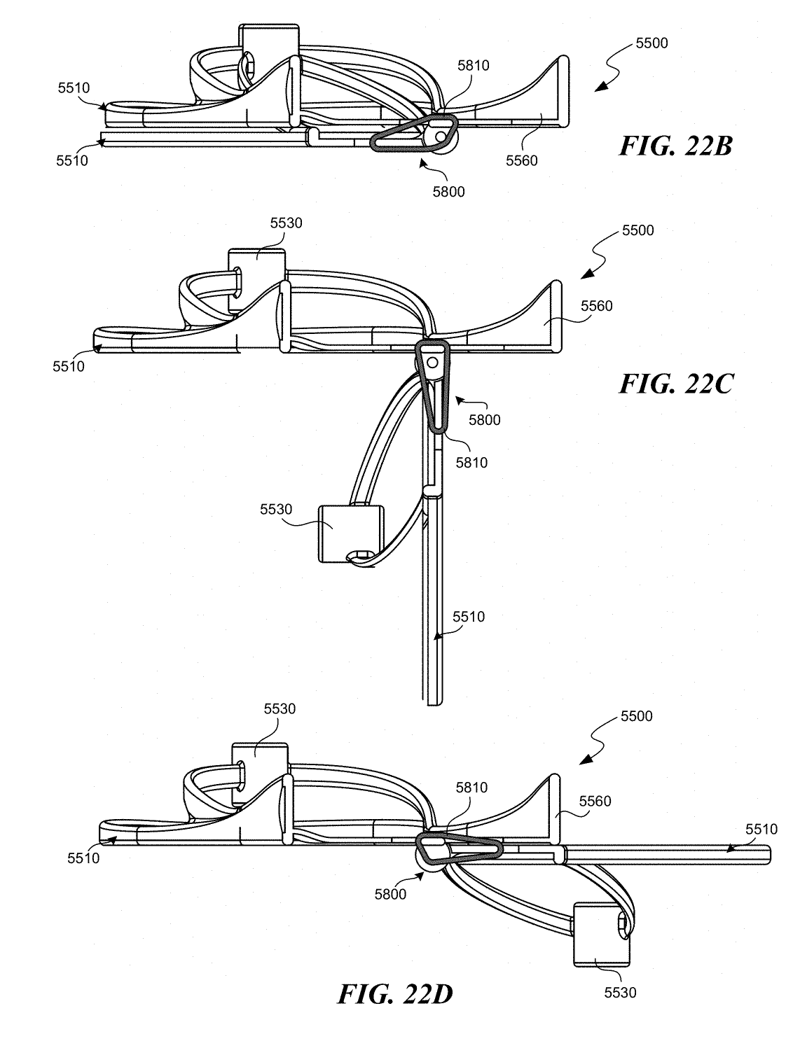

FIGS. 23A-23E illustrate perspective views of the UAV 5500 in various stages between a stowed configuration (FIG. 23A) and a deployed configuration (FIG. 23E). Correspondingly, FIGS. 24A-24E illustrate side views of the UAV 5500 in the same stages between the stowed configuration (FIG. 24A) and the deployed configuration (FIG. 24E). Arrows in each of FIGS. 24A-24E schematically indicate a biasing force from one or more of the bi-stable hinge mechanisms described herein. In FIGS. 23A and 24A, force from a bi-stable hinge mechanism tends to maintain the UAV in the stowed configuration. In FIGS. 23E and 24E, force from the bi-stable hinge mechanism tends to maintain the UAV in the deployed configuration.

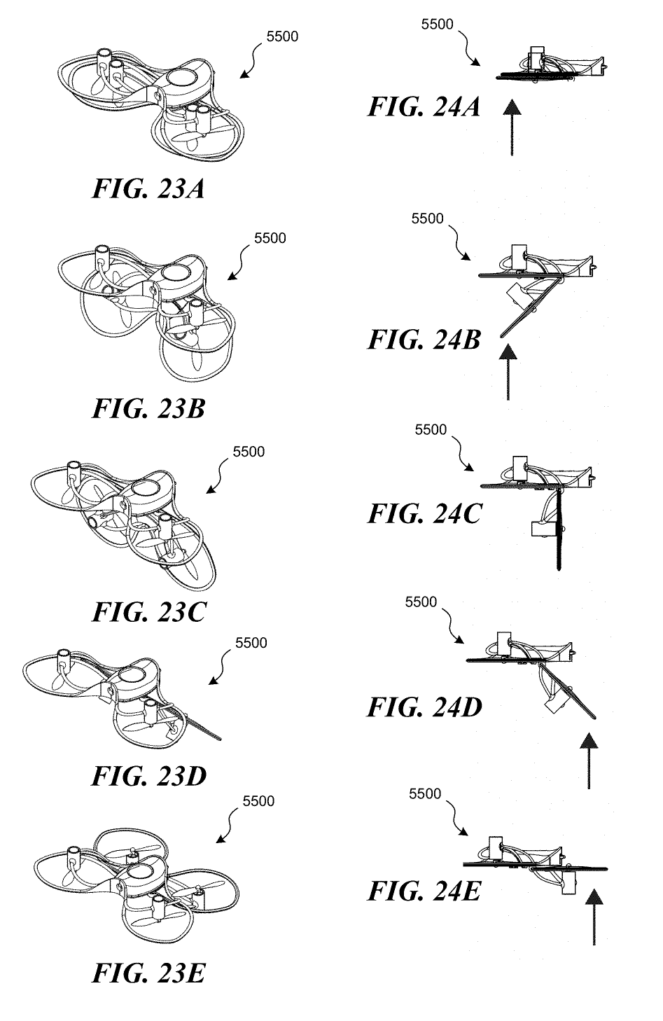

FIG. 25 illustrates a UAV 5500 configured in accordance with another embodiment of the present technology. A modular electronics unit 6110 (which can be referred to as a removable pod) can be retained or removed from a pod recess or socket 6120 in the main body portion 5560. The modular electronics unit 6110 may have features similar to the features described above with regard to other electronics modules or modular electronics units disclosed herein (e.g., the modular electronics unit 2910 described above in association with FIGS. 2 and 3). For example, the modular electronics unit 6110 may be removed for charging, storage, or modification. Similar to other modular electronics units disclosed herein, the modular electronics unit 6110 may be interchangeable with other UAV airframes and accessories disclosed herein. The modular electronics unit 6110 may be releasably retained in the socket 6120 using a plastic snap, one or more magnets, one or more electrical connectors, or other suitable releasable connectors. For example, a connector similar to a Mason jar latch can be used. The modular electronics unit 6110 can be—or can include—a self-contained camera having a screen, a number of buttons (for example, one to five buttons), and a camera module having a lens. Illumination, such as LEDs operable to provide a swirling light pattern, can surround the screen for aesthetic or other purposes.

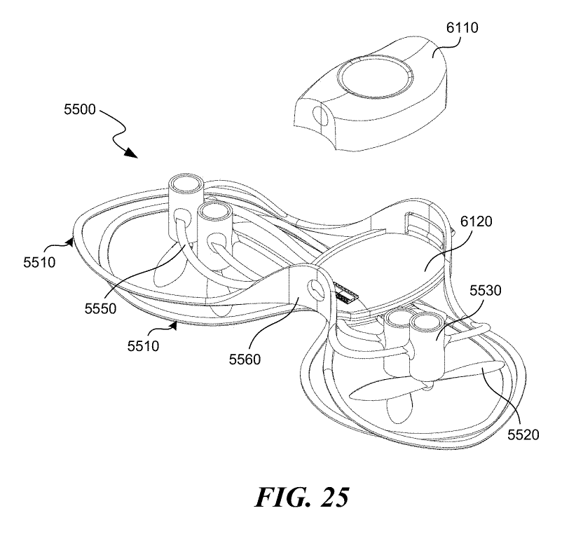

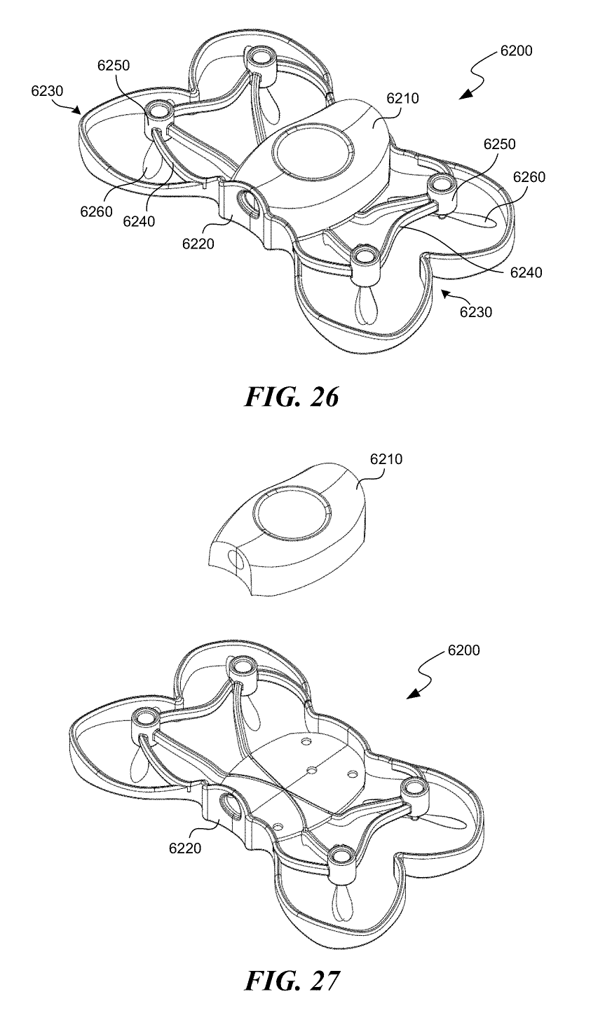

FIGS. 26 and 27 illustrate a UAV 6200 in accordance with another embodiment of the presently disclosed technology. FIG. 26 illustrates the UAV 6200 in an assembled configuration, in which a removable pod or modular electronics unit 6210 is installed in a main body 6220. The UAV 6200 can include one or more frames 6230 which do not stow or deploy, but rather remain in position for flight. The frames 6230 can include motor supports 6240 for supporting one or more motors 6250 and corresponding rotors 6260. In some embodiments, the modular electronics unit 6210 can be similar to the above modular electronics unit 6110 and/or other modular electronics units disclosed herein (for example, the modular electronics unit 2910 described above with reference to FIGS. 2 and 3). FIG. 27 illustrates the modular electronics unit 6210 removed from the main body 6220. The modular electronics unit 6210 can be retained in the main body 6220 using connectors or latches similar to those disclosed herein in connection with other pods or modular electronics units.

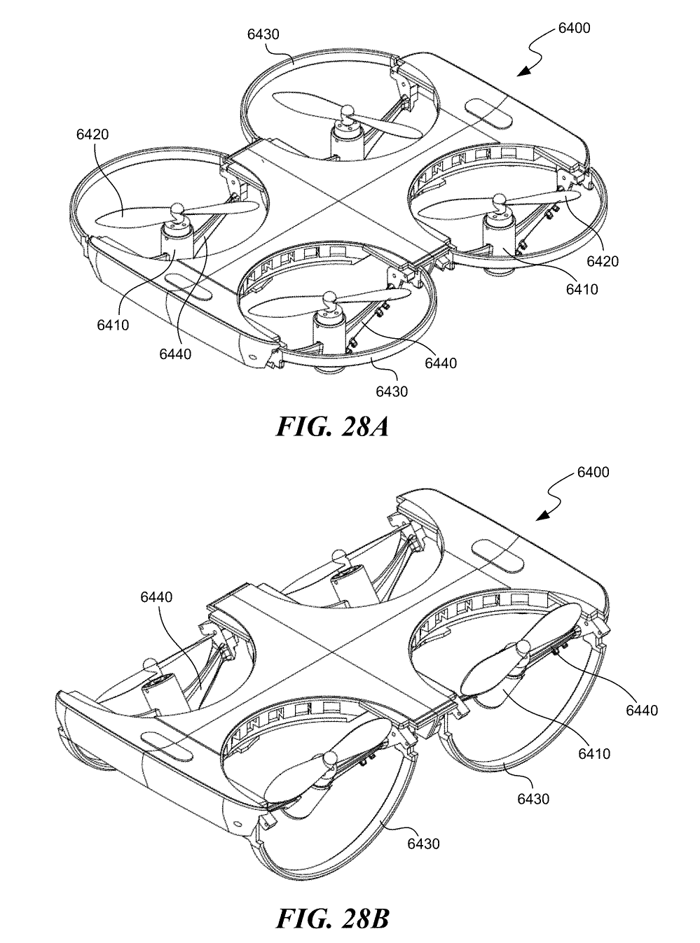

FIGS. 28A, 28B, and 280 illustrate a UAV 6400 configured in accordance with another embodiment of the presently disclosed technology. FIG. 28A illustrates a perspective view of the UAV 6400 in a deployed configuration, in which motors 6410 having corresponding rotors 6420 are positioned for flight. In some embodiments, rotor shrouds 6430 can be pivotally moved approximately 180 degrees from the deployed configuration to a stowed configuration (generally illustrated in FIG. 28C). The rotor shrouds 6430 can be spring-loaded to spring out to the deployed configuration. In some embodiments, motor supports 6440 can be pivotally moved approximately 90 degrees from the deployed configuration (illustrated in FIG. 28A) to a stowed configuration (illustrated in FIG. 28C). The motor supports 6440 can be spring-loaded to spring out to the deployed configuration. In some embodiments, the motor supports 6440 and the rotor shrouds 6430 can pivot independently of each other.

FIG. 28B illustrates a perspective view of the UAV 6400 in transition between the deployed configuration and the stowed configuration. FIG. 28C illustrates a perspective view of the UAV 6400 in the stowed configuration, in which the motors 6410, rotors 6420, rotor shrouds 6430, and motor supports 6440 have been pivoted such that the UAV 6400 is in a generally flat configuration. In some embodiments, the UAV 6400 can be a shape and size of a smartphone. In some embodiments, a release latch may be positioned to release the spring-loaded rotor shrouds 6430 and motor supports 6440 into the deployed configuration (FIG. 28A). The spring-loaded mechanism can include one or more pins positioned between the motor supports 6440 and the rotor shrouds 6430 to cause the motor supports and rotor shrouds to spring to the correct orientations. For example, as either a motor support 6440 or a rotor shroud 6430 springs out, a pin between them can cause the other to spring out. Torsion springs can be used to provide the force for the spring-loaded rotation.

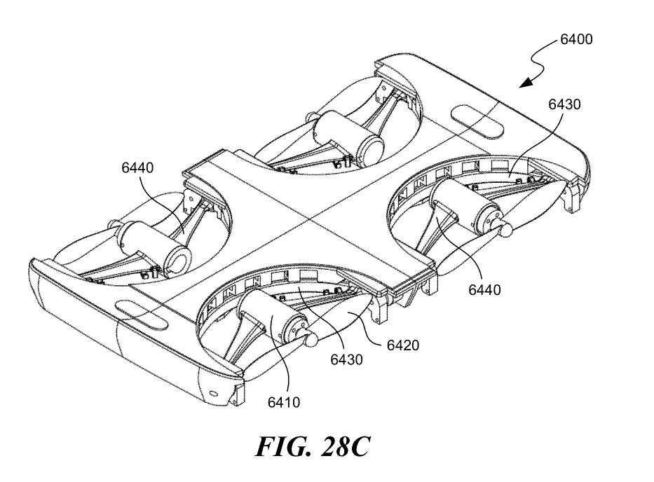

FIGS. 29-33 illustrate another foldable or stowable UAV 8000 configured in accordance with several embodiments of the presently disclosed technology. The UAV 8000 can be foldable or stowable in a manner generally similar to the stowable and deployable UAV 5500 described above with regard to FIGS. 19-24E. In other words, the UAV 8000 can be folded in half or approximately in half (or in another suitable proportion) for compact storage and unfolded or deployed for use.

As shown in FIG. 29, for example, which illustrates a perspective view of the UAV 8000 in an unfolded or deployed configuration, the UAV 8000 can include a main body 8010 having a first body portion 8020 and a second body portion 8030. The body portions 8020, 8030 are joined at a joint or hinge 8035, about which each body portion 8020, 8030 can pivot with respect to the other body portion 8020, 8030. The body portions 8020 and 8030 can each carry one or more propulsion motors 8040 for driving corresponding propulsion rotors 8050 during flight. For example, each body portion 8020, 8030 can carry two motors 8040 and corresponding rotors 8050. A number of arms or frames 8045 extending from the body portions 8020, 8030 can carry the motors 8040 and rotors 8050. Optionally, in some embodiments, each body portion 8020, 8030 can carry rotor shrouds 8055 positioned to generally surround the rotational path of each rotor 8050 to help prevent the rotors 8050 from contacting other objects.

The body 8010 can include electronic components described herein for flight control, navigation, communication, and/or the body 8010 can include camera components for capturing images and/or video, for example. In a particular embodiment, a receptacle or socket 8051 can contain a camera module permanently or semi-permanently mounted therein. In some embodiments, the body 8010 is configured to receive interchangeable modular electronics units or pods such as those described above with regard to FIGS. 2, 3, 17, 18, and/or 25, for example (such that the modular electronics units include electronics for communications with the UAV, guidance, navigation, control, power, and/or camera systems for the UAV or other vehicles). In some embodiments, the body 8010 can receive such interchangeable modular electronics units or pods in the socket 8051 (for example, similar to the socket 5320 described above with regard to FIG. 17 or the socket 6120 for the modular electronics unit 6110 described above with regard to FIG. 25).

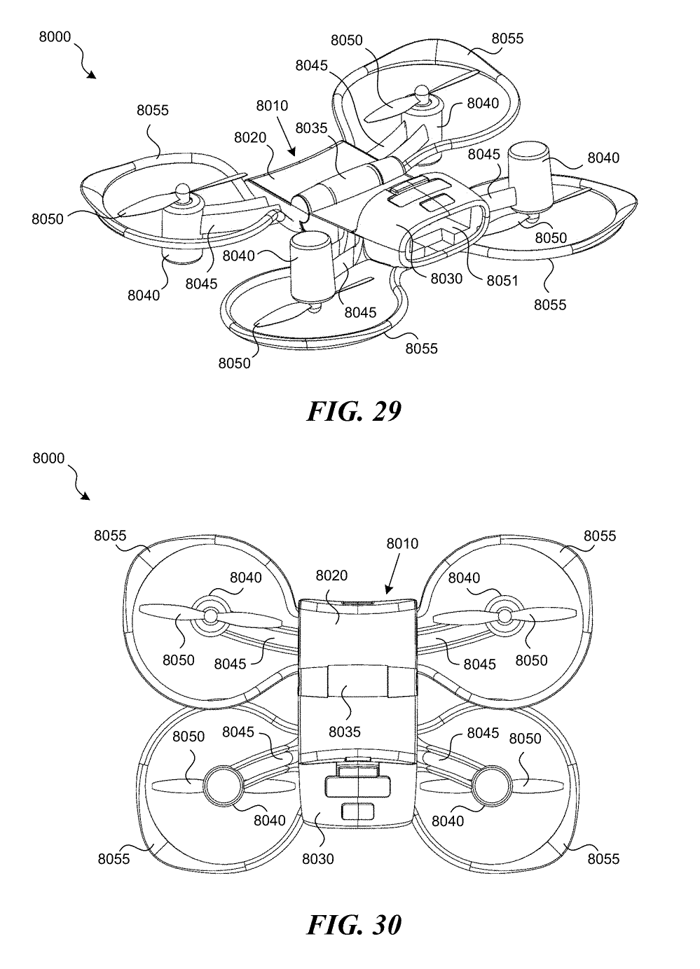

In FIG. 29, the body portions 8020, 8030 are positioned in a generally unfolded orientation with respect to each other. In such a configuration, the UAV 8000 can be operated for flight using the spaced apart motors 8040 and corresponding rotors 8050. FIG. 30 illustrates a top view of the UAV 8000 illustrated in FIG. 29, also in an unfolded or deployed configuration for flight or other operations. When in the unfolded or deployed configuration, the body portions 8020, 8030 need not unfold to a fully flat configuration. Rather, they may unfold to any suitable angle. Similarly, when the UAV 8000 is in the unfolded or deployed configuration, the frames 8045 and rotor shrouds 8055 on opposing body portions 8020, 8030 can be, but need not be, parallel or aligned with each other. Rather, they can be arranged in any manner suitable for flight. In some embodiments, the UAV 8000 can resemble the shape of a flying insect (e.g., a butterfly).

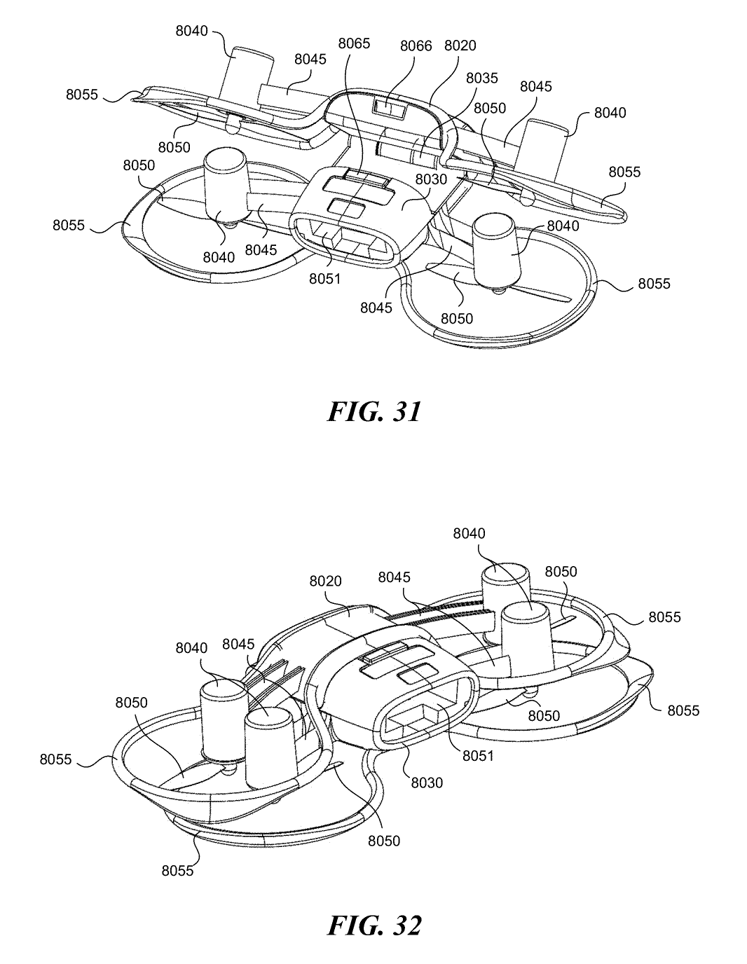

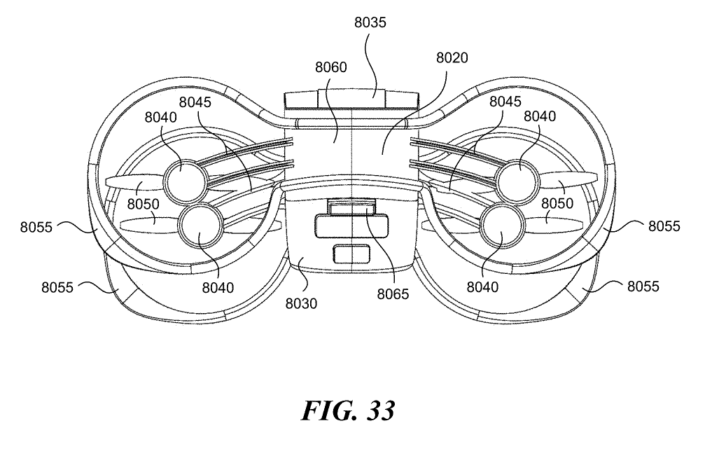

The UAV 8000 can be stowed or folded closed for compact storage or for other operations. For example, FIG. 31 illustrates a perspective view of the UAV 8000 shown in FIG. 29 in a configuration in which it is partially folded, between the unfolded or deployed configuration (FIGS. 29 and 30) and the folded or stowed configuration (generally illustrated in FIG. 32).

FIG. 32 illustrates the UAV 8000 in a folded or stowed configuration in accordance with a representative embodiment of the presently disclosed technology. In the folded configuration, the body portions 8020, 8030 have been pivoted around the hinge 8035 (FIGS. 30, 31) toward each other to be generally aligned with each other. Accordingly, in some embodiments, when the UAV 8000 is in the folded or stowed configuration, the frames 8045, rotors 8050, and/or the rotor shrouds 8055 on one body portion can be generally aligned with, and proximate to, corresponding frames 8045, rotors 8050, and/or rotor shrouds 8055 on the other body portion. For example, the rotor shrouds 8055 carried by the first body portion 8020 can be, but need not be, generally overlapping the rotor shrouds 8055 carried by the second body portion 8030. Likewise, the frames 8045 can be, but need not be, generally overlapping each other. In some embodiments, the frames 8045, motors 8040, rotors 8050, and/or shrouds 8055 are configured to allow the motors 8040 to nest together adjacent to each other to allow the body portions 8020, 8030 to fold closely together to reduce (e.g., minimize) the space required for a UAV 8000 in a folded or stowed configuration. In some embodiments, the first body portion 8020 can be nested within or against the second body portion 8030, while in other embodiments, the body portions 8020, 8030 can generally overlap each other in the folded configuration (for example, the body portions 8020, 8030 can be adjacent and parallel or nearly parallel to each other). In the folded or stowed configuration, the UAV 8000 can be securely stored in a container or strapped to a user or to an object (as described above with regard to FIG. 1, for example). In various embodiments, the body portions 8020, 8030, the frames 8045, the motors 8040, and/or the shrouds 8055 can be arranged in any suitable manner relative to each other that renders the UAV 8000 at least in part more compact than when the UAV 8000 is in the unfolded or deployed configuration (illustrated in FIGS. 29 and 30, for example).

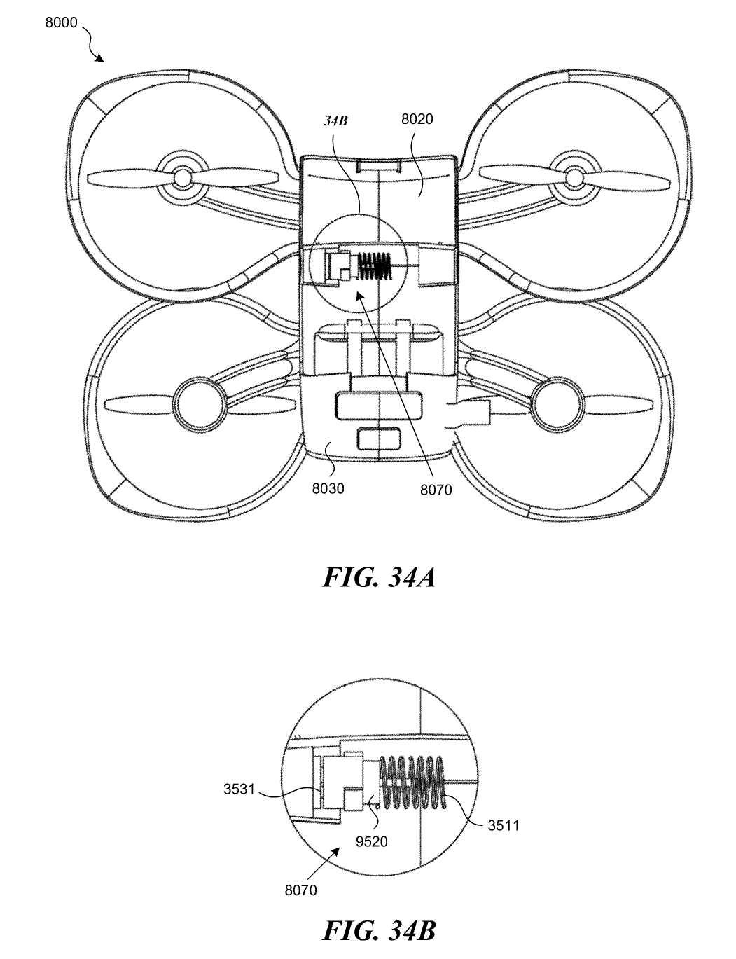

FIG. 33 illustrates a top view of the UAV 8000 in a representative folded or stowed configuration. In use, a user may hold the UAV 8000 with a top surface 8060 facing upwards and a bottom surface (opposite the top 8060) facing downwards or resting in a user's hand or on another surface. A user can slide a spring-loaded release button 8065 on the main body 8010 away from the first body portion 8020 to release a latch from a slot (for example, slot 8066 in FIG. 31). When the latch is in the slot, the latch can keep the UAV 8000 in a folded or stowed configuration until it is desired to unfold or deploy the UAV. Releasing the latch can allow the UAV 8000 to open or unfold for flight (toward the configuration generally illustrated in FIG. 29). In some embodiments, the hinge 8035 can include a spring-biased hinge mechanism or other suitable biasing mechanism to cause the first body portion 8020 and the second body portion 8030 to automatically pivot open and away from each other toward the unfolded configuration upon release of a suitable latch mechanism, such as a latch using the release button 8065. Accordingly, in some embodiments, a user can open the UAV 8000 into the deployed configuration and release the UAV 8000 for flight using one hand.

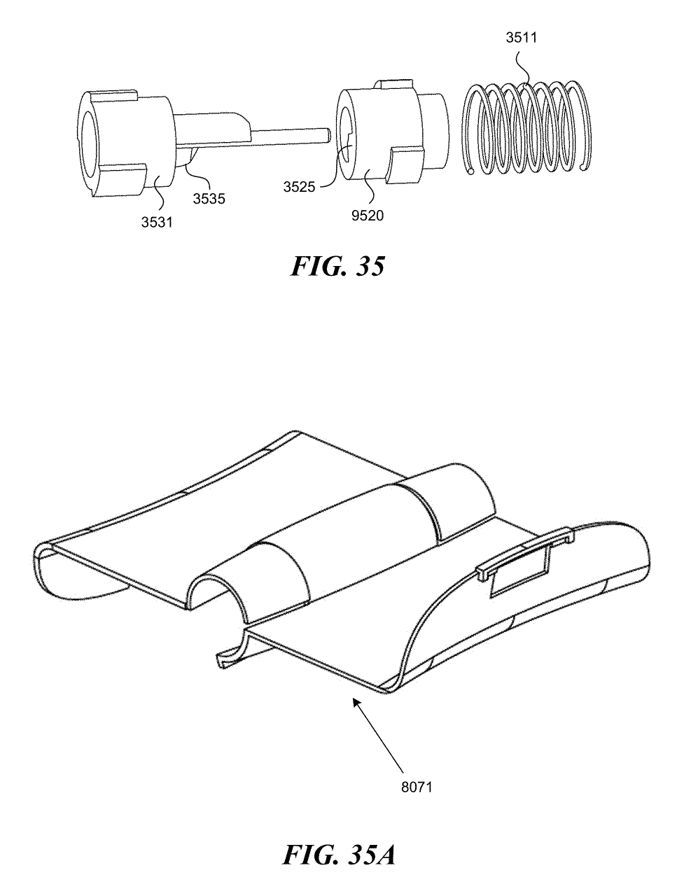

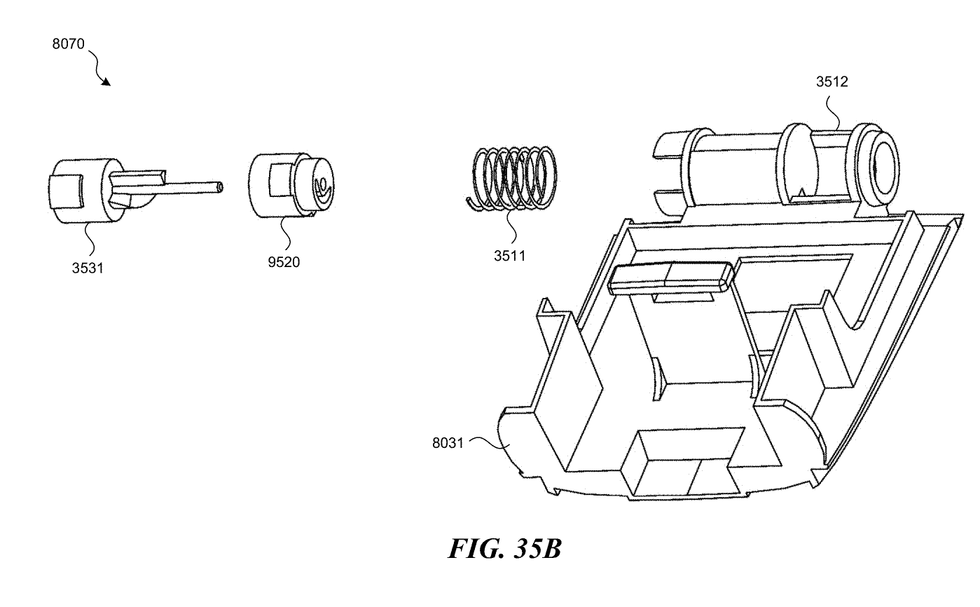

FIG. 34A illustrates a partially schematic, partially disassembled top view of a spring-biased hinge mechanism 8070 positioned in the hinge 8035 to cause the first body portion 8020 and the second body portion 8030 to spring open or automatically open, in accordance with an embodiment of the presently disclosed technology. FIG. 34B illustrates a close-up, detailed and partially schematic view of a portion of the hinge mechanism 8070 shown in FIG. 34A. Some internal elements of the hinge mechanism 8070 are generally illustrated in FIG. 35.

With reference to FIGS. 34A, 34B, and 35, the hinge mechanism 8070 includes a spring 3511 that is compressed against a first detent element 9520 to cause the first detent element 9520 to engage with a second detent element 3531. Note that only a small portion of the second detent element 3531 is visible in FIG. 34B, as it is positioned in a suitably shaped opening in the second body portion 8030, for example. The first detent element 9520 can be positioned to be rotatable with one of the body portions 8020, 8030, while the second detent element can be positioned to be rotatable with the other of the body portions 8020, 8030. For example, in a particular embodiment, the first detent element 9520 can rotate with the first body portion 8020. Accordingly, the detent elements 9520, 3531 can rotate relative to each other while being compressed together by the spring 3511.

The second detent element 3531 has an angled face 3535 which is received in the first detent element 9520 and engages with a corresponding angled face 3525 in the first detent element 9520. As the body portions 8020, 8030 pivot with respect to each other, the angled faces 3525, 3535 press and slide against each other to bias the body portions 8020, 8030 into an unfolded or deployed configuration (e.g., as generally illustrated in FIGS. 30 and 34A). The first detent element 9520 can slide along the axis of the spring 3511 as the angled faces 3525, 3535 press against each other. Accordingly, the hinge mechanism 8070 can be a monostable mechanism biasing the UAV 8000 toward an open or deployed configuration. FIG. 35A generally illustrates a cover portion 8071 that can be installed over the hinge mechanism 8070 to hold the detent elements 9520, 3531 and the spring 3511 within the main body portion 8010. FIG. 35B illustrates a segment 8031 of the second body portion 8030 (see FIG. 34A) in an exploded view with the detent elements 9520, 3531 and the spring 3511 of the hinge mechanism 8070. When assembled, the spring 3511 can be captured and compressed in a sleeve 3512 and the cover portion 8071 (FIG. 35A) connects to the segment 8031 and covers the hinge mechanism 8070.

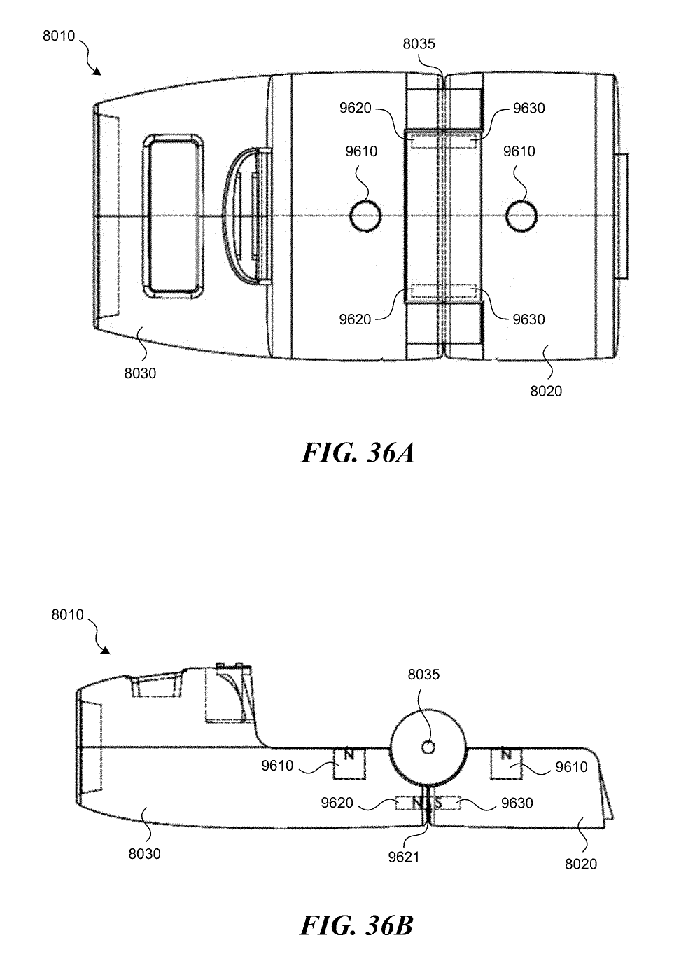

Other suitable biasing mechanisms can be used in other embodiments of the technology. For example, another representative monostable biasing mechanism is illustrated in FIGS. 36A and 36B. FIG. 36A illustrates a partially schematic top view of the main body 8010 of a UAV 8000 in accordance with another embodiment of the presently disclosed technology. FIG. 36B illustrates a partially schematic cross-sectional view of the main body 8010 of the UAV 8000 shown in FIG. 36A. As described above, the first body portion 8020 and the second body portion 8030 pivot about the hinge 8035 with respect to each other between the folded or stowed configuration (e,g., FIG. 32) and the unfolded or deployed configuration (e.g., FIG. 29). One or more magnets 9610 can be positioned in each body portion 8020, 8030 on opposite sides of the hinge 8035. The magnets 9610 can have the same polarity, such that they repel each other, causing the body portions 8020, 8030 to bias towards the unfolded or deployed configuration.

To further bias the body portions 8020, 8030 apart and to hold them in the deployed or unfolded configuration, magnets 9620, 9630 can be positioned in an abutting interface 9621 between the body portions 8020, 8030 near the hinge 8035. Such abutting magnets 9620, 9630 can have opposite polarities, such that they attract each other and help keep the main body 8010 in the unfolded configuration. The magnets 9610, 9620, and 9630 may be electromagnets, permanent magnets, or other suitable magnetic elements. In an embodiment using such magnets, the hinge 8035 may optionally include, but need not include, a spring-biased hinge mechanism such as the hinge mechanism 8070 described above with regard to FIGS. 34A-35B. In some embodiments, the main body 8010 can include a latch to hold the main body 8010 in a folded or stowed configuration as described above with regard to FIG. 33. Upon release of the latch, the magnets 9610 having like polarity repel each other and cause the main body 8010 to open or unfold.

In some embodiments of the presently disclosed technology, arrangements of an airframe, body, electronics, or mechanical parts may result in a center of mass that is not located at a central point between the motors (such as a centroid of four motors). However, the UAV can fly level by producing appropriate (and potentially, different) thrust at each rotor.

Reference in the present disclosure to “one embodiment” or “an embodiment” means that a particular feature, structure, or characteristic described in connection with the embodiment is included in at least one embodiment of the disclosed technology. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others. Similarly, various requirements are described which can be requirements for some embodiments, but not for other embodiments.

From the foregoing, it will be appreciated that specific embodiments of the disclosed technology have been described herein for purposes of illustration, but that various modifications can be made without deviating from the technology. For example, various mechanisms described herein, including deployment mechanisms or over-center mechanisms can be used in suitable combinations or versions of various form factors. In other embodiments, the UAVs may be made larger or smaller, or they may be made to clip, attach, or mount to various articles of clothing, gear, or other portable storage.

Certain aspects of the technology described in the context of particular embodiments can be combined or eliminated in other embodiments. For example, the present technology can be practiced in connection with UAVs that do not have modular electronic equipment or cameras, or in UAVs that have more or fewer rotors. In yet other embodiments, the present technology can be practiced in connection with UAVs that are in a permanently deployed configuration, while a stowed configuration may only be necessary for shipment or long-term storage.

Further, while advantages associated with certain embodiments of the disclosed technology have been described in the context of those embodiments, other embodiments can also exhibit such advantages, and not all embodiments need necessarily exhibit such advantages to fall within the scope of the technology. Accordingly, the disclosure and associated technology can encompass other embodiments not expressly shown or described herein. To the extent any of the materials incorporated herein by reference conflict with the present disclosure, the present disclosure controls.

What is claimed is:

1. An unmanned aerial vehicle (UAV), comprising:
a first body portion pivotably connected to a second body portion:
a first plurality of propulsion motors carried by the first body portion and configured to drive first corresponding propulsion rotors; and
a second plurality of propulsion motors carried by the second body portion and configured to drive second corresponding propulsion rotors; wherein
the first body portion is positioned to pivot relative to the second body portion between a folded configuration in which the first body portion is generally aligned with the second body portion, and an unfolded configuration different from the folded configuration.

2. The UAV of claim 1, further comprising:
a modular electronics unit carried by the UAV and comprising a housing, a camera carried by the housing, a battery carried by the housing and configured to provide power for the UAV, and a vehicle controller carried by the housing, the modular electronics unit being configured to be removably connected to and disconnected from the UAV, in one piece;
a latch operably connected to a button, the latch being configured to releasably retain the first body portion in the folded configuration;
a plurality of frames carried by the UAV, the frames being positioned to support the propulsion motors; and
a plurality of rotor shrouds carried by the UAV, each rotor shroud being positioned to generally surround at least one propulsion rotor of the plurality of propulsion rotors; wherein
the first body portion and the second body portion are connected via a spring-biased hinge mechanism configured to bias the first body portion and the second body portion toward the unfolded configuration;
the first body portion and the second body portion comprise a plurality of magnets configured to bias the UAV toward the unfolded configuration;
in the folded configuration, the first body portion is at least partially nested within the second body portion, at least one propulsion motor of the first plurality of propulsion motors is positioned proximate to at least one propulsion motor of the second plurality of propulsion motors, and all of the propulsion motors are positioned on a same side of the hinge; and
in the unfolded configuration, the at least one propulsion motor of the first plurality of propulsion motors is positioned on a first side of the hinge and the at least one propulsion motor of the second plurality of propulsion motors is positioned on a second side of the hinge opposite the first side.

3. The UAV of claim 1 wherein the first body portion and the second body portion are connected via a hinge, the hinge including a spring positioned to bias the first body portion and the second body portion toward the unfolded configuration.

4. The UAV of claim 1 wherein the first body portion and the second body portion comprise a plurality of magnets positioned to bias the UAV toward the unfolded configuration.

5. The UAV of claim 1 wherein when the first body portion is in the folded configuration, the first body portion is at least partially nested within the second body portion.

6. The UAV of claim 1 wherein:
in the folded configuration, at least one propulsion motor of the first plurality of propulsion motors is positioned proximate to at least one propulsion motor of the second plurality of propulsion motors; and
in the unfolded configuration, the at least one propulsion motor of the first plurality of propulsion motors is positioned away from the at least one propulsion motor of the second plurality of propulsion motors.

7. The UAV of claim 1, further comprising a modular electronics unit configured to be removably connected to and disconnected from at least one of the first body portion or the second body portion, in one piece.

8. The UAV of claim 7 wherein the modular electronics unit comprises a camera, a battery, and a vehicle controller.

9. The UAV of claim 1, further comprising:
a plurality of frames carried by the UAV, the frames being positioned to support the propulsion motors;
a plurality of rotor shrouds carried by the UAV, each rotor shroud being positioned to generally surround at least one propulsion rotor of the plurality of propulsion rotors; and
a modular electronics unit carried by the UAV and comprising a camera, a battery, and a vehicle controller; wherein
the modular electronics unit is configured to be removably connected to and disconnected from the UAV.

10. The UAV of claim 9 wherein the modular electronics unit is configured to be removably connected to and disconnected from at least one other vehicle different from the UAV.

11. An unmanned aerial vehicle (UAV) comprising:
a main body;
a plurality of frames carried by the main body; and
a plurality of motors carried by the frames;
wherein at least two frames of the plurality of frames are positioned to move relative to each other between a stowed configuration in which the frames are generally aligned proximate to each other and a deployed configuration different from the stowed configuration.

12. The UAV of claim 11 wherein:
the main body comprises a first body portion and a second body portion pivotably connected to the first body portion;
a first frame of the plurality of frames is carried by the first body portion;
a second frame of the plurality of frames is carried by the second body portion; and
in the stowed configuration, the first body portion and the second body portion generally overlap each other.

13. The UAV of claim 12 wherein the first body portion includes a first magnet having a first polarity, the second body portion includes a second magnet having a second polarity, the first polarity is different from the second polarity, and the first and second magnets are positioned to repel each other in the stowed configuration.

14. The UAV of claim 12 wherein the main body comprises a latch mechanism positioned to releasably hold the first body portion and the second body portion in the stowed configuration.

15. The UAV of claim 11 wherein the at least two frames are positioned to move relative to each other via a spring-biased hinge mechanism.

16. The UAV of claim 11 wherein the main body includes a socket configured to receive an interchangeable modular electronics unit including a camera and electronics for communications with the UAV.

17. The UAV of claim 11, further comprising a modular electronics unit configured to be removably connected to and disconnected from the main body, in one piece.

18. A modular electronics unit for an unmanned aerial vehicle (UAV) comprising:
a housing;
communication electronics carried by the housing and configured to facilitate communication with the UAV;
control electronics carried by the housing and configured to operate the UAV; and
a connector carried by the housing and configured to connect the modular electronics unit to the UAV; wherein
the modular electronics unit is configured to be carried by the UAV,
the modular electronics unit is configured to be removably connected to the UAV and to at least one other vehicle, and
the control electronics are further configured to operate the at least one other vehicle.

19. The modular electronics unit of claim 18, further comprising:
a camera carried by the housing; and
a battery carried by the housing and configured to provide power to the UAV.

20. The modular electronics unit of claim 18 wherein the at least one other vehicle is another UAV, a balancing two-wheel platform, a self-propelled underwater platform, a ground vehicle, or a tripod having a gimbal mechanism.

21. The modular electronics unit of claim 18 wherein the UAV comprises a first body portion pivotably connected to a second body portion, and wherein the modular electronics unit is configured to be removably received in a socket in the first body portion or the second body portion.

22. A method of manufacturing a UAV, the method comprising:
connecting a first body portion to a second body portion via a rotatable connection, with the first body portion and the second body portion positioned to be rotated toward each other into a folded configuration and away from each other into an unfolded configuration via corresponding one-handed operations;
connecting a first frame to the first body portion, and a second frame to the second body portion; and
connecting a first propulsion motor to the first frame a second propulsion motor to the second frame.

23. The method of claim 22, further comprising connecting a latch element to the first body portion or the second body portion, with:
the latch element positioned to hold the first body portion and the second body portion in the folded configuration; and
the latch positioned for one-handed operation by a user.

24. The method of claim 22 wherein connecting the first body portion to the second body portion via the rotatable connection comprises positioning a spring element to bias the rotatable connection to cause the first body portion and the second body portion to be moved into the unfolded configuration.

25. The method of claim 22 wherein connecting the first body portion to the second body portion via the rotatable connection comprises positioning a plurality of magnets in the first body portion and the second body portion to bias the first body portion and the second body portion toward the unfolded configuration.
